(19) United States
(12) Patent Application Publication
(10) Pub. No.: US 2015/0347773 A1
(43) Pub. Date: Dec. 3, 2015

(54) METHOD AND SYSTEM FOR IMPLEMENTING DATA SECURITY POLICIES USING DATABASE CLASSIFICATION

(71) Applicant: Intuit Inc., Mountain View, CA (US)

(72) Inventors: William Q. Bonney, San Diego, CA (US); Brad A. Rambur, Carlsbad, CA (US); Luis Felipe Cabrera, Bellevue, WA (US); M. Shannon Lietz, San Marcos, CA (US)

(73) Assignee: INTUIT INC., Mountain View, CA (US)

(21) Appl. No.: 14/289,817

(22) Filed: May 29, 2014

(51) Int. Cl. G06F 21/62; G06F 17/30

(52) U.S. Cl. CPC G06F 21/6218; G06F 17/30598

(57) ABSTRACT

Access to a database is obtained, the database containing data that is potentially of one or more data types and/or data security classifications. The data in the database is scanned to determine the types and/or data security classifications of the data in the database. Then based, at least in part, on the determined types and/or data security classifications of the data in the database a database security classification is associated with the entire database and used to select one or more security measures to be applied to the entire database, at the database level, in accordance with defined data security policies.

### BACKGROUND

As various forms of distributed computing, such as cloud computing, have come to dominate the computing landscape, security has become a bottleneck issue that currently prevents the complete migration of various capabilities and systems associated with sensitive data, such as financial data, to cloud-based infrastructures, and/or other distributed computing models. This is because many owners and operators of data are extremely hesitant to allow their data and resources to be accessed, processed, stored, and/or otherwise used, by virtual assets in the cloud.

In a cloud computing environment, various assets, such as, but not limited to, virtual machine instances, data stores/databases, communications systems, and various services, are created, launched, or instantiated, in a production environment as needed for use by an application and/or “owner” of the asset.

Herein the terms “owner” and “user” of an asset include, but are not limited to, applications, systems, and sub-systems of software and/or hardware, as well as persons or entities associated with an account, or other identity, through which the asset is purchased, approved managed, used, and/or created.

One major security issue in a cloud computing environment, and any computing or production environment, is to ensure that sensitive data, such as financial data, is protected using a level of security commensurate with the sensitivity of the data. For instance, it would be highly desirable to protect data representing a party's social security number using the highest levels of security, such as encryption of a defined minimum length. On the other hand, data indicating a party's average monthly spending in a financial category, such as entertainment, might not need the same level of protection.

Complicating the situation is the fact that it is often the case that both highly sensitive data and less sensitive data are often stored in the same database, and/or using the same hardware systems. As an example, multiple databases, in some cases each having different owners, and each including data of varying levels of sensitivity, are often implemented using the same hardware system, such as a back-end server.

Currently, data in databases is typically “protected” by protecting the hardware systems, such as back-end servers implementing multiple databases, e.g., by protecting the entire processing layer and associated hardware. This protection typically involves the use of an access control layer physically and/or logically removed from the actual databases and the hardware systems, such as back-end servers, implementing the databases. Typically, these access control layers include hardware and software components such as, but not limited to, firewalls, gateways, and/or any other access control devices used to control access to various systems and prevent unauthorized access to other layers and components in one or more computing environments. Currently, the access control devices in the access control layer are largely static hardware-based systems that are designed to control access to entire computing environments, systems, and layers including multiple components such as multiple servers and databases.

While the use of currently available access control layers and devices works reasonable well in relatively static computing environments, the advent of cloud computing, and the ability to dynamically generate, and terminate, various virtual assets, including databases/data stores, essentially at will and in any numbers desired, has created the need for a more flexible, dynamic, and localized way to implement data security policy.

What is needed is a method and system for ensuring compliance with one or more data security policies that is implemented at the individual database level to provide the flexibility needed to readily adapt to the dynamic nature of a cloud computing environment, or any computing environment where the type and number of assets, e.g., databases, is capable of rapidly changing. In addition, it is desirable that the implementation and operation of the data security policies be accomplished without a user of the data, such as an application developer, being forced to take any additional actions, i.e., it is desirable that the implementation and operation of the data security policies be substantially invisible to the user of the data.

### SUMMARY

In one embodiment, a method and system for implementing data security policies using database classification includes defining one or more data security policies to be applied to data. In one embodiment, database security policy compliance data is generated that represents instructions for applying one or more database security measures to databases containing data in order to ensure compliance of the databases, and data therein, with the one or more data security policies. In one embodiment, each of the one or more database security measures is associated with a different database security classification.

In one embodiment, access to a database is obtained, the database containing data that is potentially of one or more data types, and/or data security classifications. In one embodiment, the data in the database is scanned to determine the types of data, and/or data security classifications of the data, in the database. In one embodiment, based, at least in part, on the determined types of data, and/or data security classifications of the data, in the database, a database security classification to be applied to the entire database is determined. Database security classification data for the database indicating the database security classification to be applied to the database is then generated. In one embodiment, the database security classification data for the database is associated with the database and is then used to select one or more database security measures of the database security policy compliance data to be applied to the database.

In one embodiment, a method and system for implementing data security policies using database classification includes defining one or more data security policies to be applied to data. In one embodiment, data security policy compliance data representing instructions for applying one or more data security measures to data in databases in order to ensure compliance of the data in the databases with the one or more data security policies is generated. In one embodiment, each of the instructions for applying one or more data security measures is associated with a different data security classification.

In one embodiment, database security policy compliance data representing instructions for applying one or more database security measures to databases containing data in order to ensure compliance of the databases with the one or more database security policies is also generated. In one embodiment, each of the instructions for applying one or more database security measures is associated with a different database security classification.

In one embodiment, access to a database containing data that is potentially of one or more data types, and/or one or more data security classifications, is obtained. In one embodiment, the data in the database is scanned to determine the types of data in the database. In one embodiment, for each type of data determined to be in the database, the data security policy compliance data is used to ensure the security measures applied to the data are in conformance with the one or more data security policies.

In one embodiment, the data in the database is also scanned, as part of the same scan, or in a separate scan, to determine the security classifications and/or security measures applied to the data in the database. In one embodiment, based, at least in part, on the determined security classifications and/or security measures applied to the data in the database, a database security classification to be applied to the entire database is determined. In one embodiment, database security classification data for the database is then generated indicating the database security classification to be applied to the database. The database security classification data is then associated with the database and used to select a set of database security measures of the database security policy compliance data to be applied to the database.

### BRIEF DESCRIPTION OF THE DRAWINGS

FIG. 1 is a functional block diagram showing the interaction of various elements for implementing one embodiment;

FIG. 2 is a more detailed functional diagram of the interaction of some of the elements associated with exemplary embodiments of FIG. 1;

FIG. 3 is a flow chart depicting a process for implementing data security policies using database classification in accordance with one embodiment; and

FIG. 4 is a flow chart depicting a process for implementing data security policies using database classification in accordance with one embodiment.

Common reference numerals are used throughout the FIG.s and the detailed description to indicate like elements. One skilled in the art will readily recognize that the above FIG.s are examples and that other architectures, modes of operation, orders of operation and elements/functions can be provided and implemented without departing from the characteristics and features of the invention, as set forth in the claims.

### DETAILED DESCRIPTION

Embodiments will now be discussed with reference to the accompanying FIG.s, which depict one or more exemplary embodiments. Embodiments may be implemented in many different forms and should not be construed as limited to the embodiments set forth herein, shown in the FIG.s, and/or described below. Rather, these exemplary embodiments are provided to allow a complete disclosure that conveys the principles of the invention, as set forth in the claims, to those of skill in the art.

In accordance with one embodiment, access to a database containing data that is potentially of one or more data types is obtained. The data in the database is then scanned to determine the types of data in the database. Then, based on the determined types of data in the database, a database security classification is assigned to the database. The database security classification of the database is then used to select one or more database security measures to be applied to the database in order to comply with defined data security policy at the individual database level.

In accordance with one embodiment, a method and system for implementing data security policies using database classification includes a process for implementing data security policies using database classification implemented, at least in part, by one or more computing systems and/or computing entities in a production environment.

Herein, the term “production environment” includes the various components, or assets, including databases, used to deploy, implement, access, and use, a given application as that application is intended to be used. In various embodiments, production environments include multiple assets, including databases, which are combined, communicatively coupled, virtually and/or physically connected, and/or associated with one another, to provide the production environment implementing the application.

As specific illustrative examples, the assets making up a given production environment can include, but are not limited to, one or more computing environments used to implement the application in the production environment such as a data center, a cloud computing environment, a dedicated hosting environment, and/or one or more other computing environments in which one or more assets used by the application in the production environment are implemented; one or more databases used to store data to develop, deploy, or implement/operate the application in the production environment; one or more computing systems or computing entities used to develop, deploy, or implement/operate the application in the production environment; one or more virtual assets, including virtual databases/data stores used to develop, deploy, or implement/operate the application in the production environment; one or more supervisory or control systems, such as hypervisors or other monitoring systems, used to monitor and control assets and/or components of the production environment; one or more communications channels for sending and receiving data used to develop, deploy, or implement/operate the application in the production environment; one or more access control systems for limiting access to various components/assets of the production environment, such as firewalls and gateways; one or more traffic and/or routing systems used to direct, control, and/or buffer, data traffic to assets of the production environment, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement the application in the production environment; one or more internal or external services used to develop, deploy, implement, and/or operate the application in the production environment; one or more backend systems, such as back-end servers or other hardware used to host assets and process data or store data and develop, deploy, implement, and/or operate the application in the production environment; one or more software systems used to develop, deploy, implement, and/or operate the application in the production environment; and/or any other assets/components making up an actual production environment in which an application is deployed, implemented, accessed, and run, e.g., operated, as discussed herein, and/or as known in the art at the time of filing, and/or as developed after the time of filing.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known environments, e.g., “trusted” environments, or unknown, e.g., “untrusted” environments.

Typically trusted computing environments are those where the assets, infrastructure, communication and networking systems, and security systems associated with the computing systems and/or virtual assets making up the trusted computing environment, are either under the control of, or known to, a party, such as a data center.

In contrast, unknown, or untrusted computing environments are environments and systems where the assets, components, infrastructure, communication and networking systems, and security systems implemented and associated with the computing systems and/or virtual assets making up the untrusted computing environment, are not under the control of, and/or are not known by, a party, and/or are dynamically configured with new elements capable of being added that are unknown to the party, such as a public could computing environment, multi-tenancy computing environment, or the Internet.

It is often the case that to develop, deploy, implement, and/or operate an application, data must be transferred between a first computing environment that is an untrusted computing environment and a trusted computing environment. However, in other situations a party may wish to transfer data between two trusted computing environments, and/or two untrusted computing environments.

As used herein, the terms “computing system” and “computing entity”, include, but are not limited to, a virtual asset; a server computing system; a workstation; a desktop computing system; a mobile computing system, including, but not limited to, smart phones, portable devices, and/or devices worn or carried by a user; a database, database system, data store, or storage cluster; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

In addition, as used herein, the terms computing system and computing entity, can denote, but are not limited to, systems made up of multiple: virtual assets; server computing systems; workstations; desktop computing systems; mobile computing systems; databases, database systems, data stores, or storage clusters; switching systems; routers; hardware systems; communications systems; proxy systems; gateway systems; firewall systems; load balancing systems; or any devices that can be used to perform the processes and/or operations as described herein.

As used herein, the term “database” includes any computing system or memory system capable of storing data. In various embodiments, databases can be implemented in software, hardware, and/or a combination of software and hardware, and/or any combination of physical or virtual systems.

In accordance with one embodiment, a method and system for implementing data security policies using database classification includes a process for implementing data security policies using database classification implemented, at least in part, by one or more virtual assets in a cloud computing environment. In one embodiment, the cloud computing environment is part of, or is, the production environment of the application.

In various embodiments, one or more cloud computing environments are used to create, and/or deploy, and/or operate, an application that can be any form of cloud computing environment, such as, but not limited to, a public cloud; a private cloud; a virtual private network (VPN); a subnet; a Virtual Private Cloud (VPC); a sub-net or any security/communications grouping; or any other cloud-based infrastructure, sub-structure, or architecture, as discussed herein, and/or as known in the art at the time of filing, and/or as developed after the time of filing.

In many cases, a given application or service may utilize, and interface with, multiple cloud computing environments, such as multiple VPCs, in the course of being created, and/or deployed, and/or operated.

As used herein, the term “virtual asset” includes any virtualized entity or resource, and/or any virtualized part of a physical, actual, or “bare metal” entity. In various embodiments, the virtual assets can be, but are not limited to, virtual machines, virtual servers, and instances implemented in a cloud computing environment; databases, database systems, and/or data stores associated with a cloud computing environment, and/or implemented in a cloud computing environment; services associated with, and/or delivered through, a cloud computing environment; communications systems used with, part of, or provided through, a cloud computing environment; and/or any other virtualized assets and/or sub-systems of “bare metal” physical devices such as mobile devices, remote sensors, laptops, desktops, point-of-sale devices, ATMs, electronic voting machines, etc., located within a data center, within a cloud computing environment, and/or any other physical or logical location, as discussed herein, and/or as known/available in the art at the time of filing, and/or as developed/made available after the time of filing.

In various embodiments, any, or all, of the assets making up a given production environment discussed herein, and/or as known in the art at the time of filing, and/or as developed after the time of filing, can be implemented as virtual assets.

In one embodiment, two or more assets, such as computing systems, databases, and/or virtual assets, and/or two or more computing environments, are connected by one or more communications channels including but not limited to, Secure Sockets Layer communications channels and various other secure communications channels, and/or distributed computing system networks, such as, but not limited to: a public cloud; a private cloud; a virtual private network (VPN); a subnet; any general network, communications network, or general network/communications network system; a combination of different network types; a public network; a private network; a satellite network; a cable network; or any other network capable of allowing communication between two or more assets, computing systems, and/or virtual assets, as discussed herein, and/or available or known at the time of filing, and/or as developed after the time of filing.

As used herein, the term “network” includes, but is not limited to, any network or network system such as, but not limited to, a peer-to-peer network, a hybrid peer-to-peer network, a Local Area Network (LAN), a Wide Area Network (WAN), a public network, such as the Internet, a private network, a cellular network, any general network, communications network, or general network/communications network system; a wireless network; a wired network; a wireless and wired combination network; a satellite network; a cable network; any combination of different network types; or any other system capable of allowing communication between two or more assets, virtual assets, and/or computing systems, whether available or known at the time of filing or as later developed.

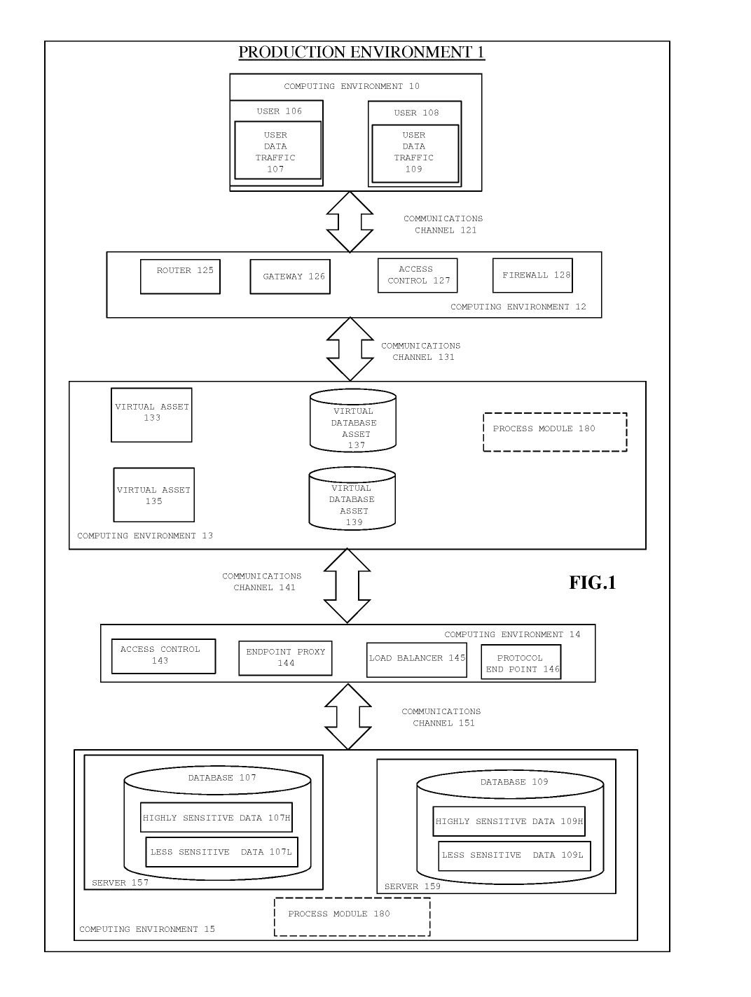

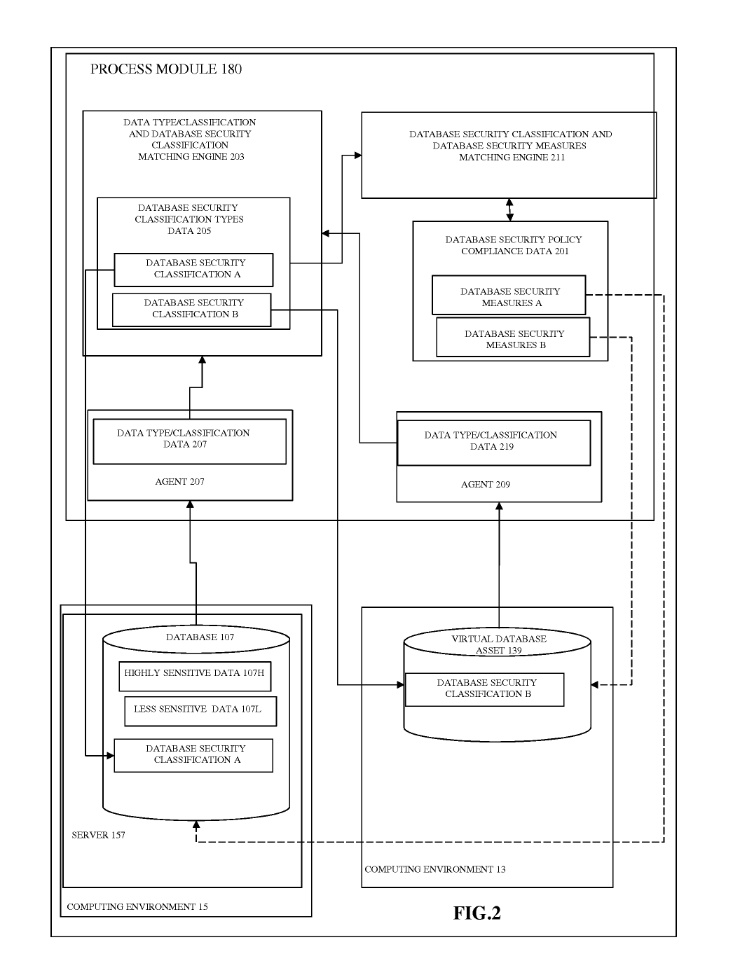

FIG. 1 is a functional diagram of the interaction of various elements associated with exemplary embodiments of the methods and systems for implementing data security policies using database classification discussed herein. FIG. 2 is a more detailed functional diagram of the interaction of some of the elements of FIG. 1 associated with one embodiment of the methods and systems for implementing data security policies using database classification discussed herein.

Of particular note, the various elements/assets in FIG. 1 and FIG. 2 are shown for illustrative purposes as being associated with production environment 1 and specific computing environments within production environment 1. However, the exemplary placement of the various elements/assets within these environments and systems in FIG. 1 and FIG. 2 is made for illustrative purposes only and, in various embodiments, any individual element/asset shown in FIG. 1 and FIG. 2, or combination of elements/assets shown in FIG. 1 and FIG. 2, can be implemented and/or deployed on any of one or more various computing environments or systems, and/or architectural or infrastructure components, such as one or more hardware systems, one or more software systems, one or more data centers, more or more clouds or cloud types, one or more third party service capabilities, or any other computing environments, architectural, and/or infrastructure components, as discussed herein, and/or as known in the art at the time of filing, and/or as developed/made available after the time of filing.

In addition, the elements shown in FIG. 1 and FIG. 2, and/or the computing environments, systems and architectural and/or infrastructure components, deploying the elements shown in FIG. 1 and FIG. 2, can be under the control of, or otherwise associated with, various parties or entities, or multiple parties or entities, such as, but not limited to, the owner of a data center, a party and/or entity providing all or a portion of a cloud-based computing environment, the owner or a provider of an application or service, the owner or provider of one or more resources, and/or any other party and/or entity providing one or more functions, and/or any other party and/or entity as discussed herein, and/or as known in the art at the time of filing, and/or as made known after the time of filing.

In accordance with one embodiment, one or more databases are provided for use in a production environment. In one embodiment, the one or more databases are implemented on one or more hardware systems, such as server systems, in a computing environment. In one embodiment, the one or more databases are presented to various users, such as an application or application developer, as physical databases, and/or as virtual database assets deployed in a cloud-based computing environment. In various embodiments, virtual database assets are, in fact, hosted and implemented on one or more hardware systems, such as server systems, in a computing environment that is separate from, and/or isolated from, the cloud computing environment, such as a data center.

As noted above, FIG. 1 shows production environment 1. As seen in FIG. 1, in this specific illustrative example, production environment 1 includes computing environments 10, 12, 13, 14, and 15, used to implement an application in production environment 1. As seen in FIG. 1, production environment 1 includes computing environment 10, for instance a local area network, or the Internet, that includes users 106 and 108 generating user data traffic 107 and 109, respectively, using one or more computing systems. As seen in FIG. 1, user data traffic 107 and 109 is provided to computing environment 12, such as an access control layer and/or Internet Service Provider (ISP) service, via communications channel 121.

As seen in FIG. 1, production environment 1 includes computing environment 12 which, in turn, includes, as illustrative examples, one or more assets such as router 125, gateway 126, access control 127, and firewall 128. As seen in FIG. 1, in this specific illustrative example, computing environment 12 is commutatively coupled to computing environment 13 of production environment 1 by communications channel 131.

As seen in FIG. 1, production environment 1 also includes computing environment 13. In this specific illustrative example, computing environment 13 is a cloud computing environment and includes various virtual assets 133, 135, and virtual database assets 137 and 139. As discussed below, in one embodiment, virtual database assets 137 and 139 are, in fact, hosted and implemented on server 157 and/or server 159 of computing environment 15. In one embodiment, computing environment 13 also includes process module 180 for implementing at least part of the method and system for implementing data security policies using database classification locally in computing environment 13. Process module 180 is discussed in more detail below.

In the specific illustrative example of FIG. 1, production environment 1 includes computing environment 14, such as a second access control layer, commutatively coupled to computing environment 13 by communications channel 141. In this specific illustrative example, computing environment 14 includes assets such as exemplary access control systems, e.g., one or more of access control 143, endpoint proxy 144, load balancer 145, and protocol endpoint 146.

As seen in the specific illustrative example of FIG. 1, production environment 1 includes computing environment 15 commutatively coupled to computing environment 14 by communications channel 151. In one embodiment, computing environment 15 is a processing environment, or processing layer, such as a data center where one or more hardware systems, such as server 157 and server 159, are implemented. As can be seen in FIG. 1, servers 157 and 159, in this specific illustrative embodiment, include, or host, databases 107 and 109. In one embodiment, computing environment 15 also includes process module 180 for implementing at least part of the method and system for implementing data security policies using database classification locally in computing environment 15. Process module 180 is discussed in more detail below.

As discussed above, one major security issue in a cloud computing environment, and any computing or production environment, is to ensure that sensitive data, such as financial data, is protected using a level of security commensurate with the sensitivity of the data. However, complicating the situation is the fact that it is often the case that both highly sensitive data, such as highly sensitive data 107H of database 107 and highly sensitive data 109H of database 109, and less sensitive data, such as less sensitive data 107L of database 107 and less sensitive data 109L of database 109, are often stored in the same database, such as database 107 or database 109.

As also noted above, currently, data, such as highly sensitive data 107H and less sensitive data 107L of database 107 and highly sensitive data 109H and less sensitive data 109L of database 109 is typically “protected” by protecting the hardware systems, such as servers 157 and 159, implementing the databases, such as databases 107 and 109, e.g., by protecting the entire processing layer, such as computing environment 15, and the associated hardware such as server 157 and server 159. This protection typically includes providing an access control layer, such as computing environment 12 and/or computing environment 14, that is physically and/or logically removed from the actual databases and the hardware systems, such as servers 157 and 159, implementing databases 107 and 109 in computing environment 15.

Typically, these access control layers include hardware and software components such as, but not limited to: firewalls, such as firewall 128 in computing environment 12; gateways, such as gateway 126 in computing environment 12; access control systems, such as access control 127 in computing environment 12 and access control system 143 in computing environment 14; and various components of other systems such as load balancer 145 in computing environment 14; and/or any other access control devices used to control access to various systems and prevent unauthorized access to other layers and components in one or more computing environments.

Currently, the access control devices in the access control layer, such as computing environment 12 and/or computing environment 14, are largely static hardware-based systems that are designed to control access to entire computing environments, systems, and layers, such as computing environment 15, including multiple components such as servers 157 and 159 and databases 107 and 109.

While the use of currently available access control layers and devices, such as computing environment 12 and/or computing environment 14, works reasonable well in relatively static computing environments, the advent of cloud computing, and the ability to dynamically generate, and terminate, various virtual assets, including virtual databases/data stores, such as virtual database assets 137 and 139 in computing environment 13, essentially at will and in any numbers desired, has created a need for a more flexible, dynamic, and localized way to implement data security policy.

To address this deficiency in the prior art, in accordance with one embodiment, one or more data security policies to be applied to data are defined. In one embodiment, the one or more data security policies are defined by the owners of the data stored in the databases. In other embodiments, the one or more data security policies are defined by one or more of, the provider of the production environment, the provider or developer of an application, the provider of a cloud computing infrastructure, and/or any other parties or entities, as discussed herein, and/or as known in the art at the time of filing, and/or as become known after the time of filing.

As used herein the term “security policy” includes any security policy, regulatory policy, encryption policy, access policy, storage policy, security event reaction policy, or any other policy or protocol used to protect data, assets, applications, services, enterprises, computing environments, and/or production environments, as discussed herein, and/or as known in the art at the time of filing, and/or as developed after the time of filing.

As specific illustrative examples, in various embodiments, the data security policies include, but are not limited to, one or more data security policies requiring specific encryption, or a defined level of encryption, for data; one or more data security policies requiring the use of tokens or tokenization of data; one or more data security policies requiring hashes, and/or one-way hashes, of data; one or more data security policies requiring log records be kept tracking all modifications to data; one or more data security policies requiring the logging of all access, or attempts to access, the data; one or more data security policies requiring all access to the data be authenticated; one or more data security policies requiring specific identification/authentication procedures, such as mandatory multifactor authentication; one or more data security policies requiring all access to the data be associated with authorized roles; one or more data security policies requiring the logging of various access, or attempts to access, the data; one or more data security policies requiring the logging of various processing, or attempts to process or manipulate, the data; one or more data security policies delineating the protective actions to be applied to the data in the event of a generalized or specific security event; and/or any other data security policies, or combination of security policies, as discussed herein, and/or as known in the art at the time of filing, and/or as become known in the art after the time of filing.

In one embodiment, once the data security policies to be applied to data are defined, database security policy compliance data is generated. In one embodiment, the database security policy compliance data represents, or includes, instructions for applying one or more database security measures to databases containing data in order to ensure compliance of the databases with the one or more data security policies at the database level. In one embodiment, each of the one or more database security measures is associated with a different database security classification, calculated as discussed below.

Consequently, in one embodiment, the database security policy compliance data represents, or includes, instructions for applying one or more database security measures to databases containing data that include, but are not limited to, applying specific encryption, or a defined level of encryption, for the entire databases; the use of tokens or tokenization of data in the databases; applying hashes and/or one-way hashes of data in the databases; logging all modifications to data in the databases; logging all access, or attempts to access, the data in the databases; requiring all access to the data in the databases be authenticated; implementing specific identification/authentication procedures, such as mandatory multifactor authentication; requiring that all access to the databases be associated with authorized roles; logging specific types of access, or attempts to access, the data in the databases; logging various processing, or attempts to process or manipulate, the data in the databases; applying one or more protective actions to the databases in the event of a generalized or specific security event; and/or any other database security policy compliance data and database security measures deemed necessary to ensure database conformance with the data security policies, as discussed herein, and/or as known in the art at the time of filing, and/or as become known in the art after the time of filing.

FIG. 2 shows a more detailed block diagram of a portion of production environment 1 of FIG. 1. Shown in FIG. 2 are process module 180; database 107 implemented on server 157 in computing environment 15; and virtual database asset 139 in computing environment 13.

As seen in FIG. 2, in one embodiment, process module 180 includes database security policy compliance data 201 that includes instructions for implementing/applying database security measures, or sets of database security measures, shown as database security measures A and database security measures B in FIG. 2, to be applied to database 107 and/or virtual database asset 139 based, at least in part, on a database security classification, e.g., database security classification A and database security classification B associated with database 107 and/or virtual database asset 139, as discussed in more detail below.

In one embodiment, once the database security policy compliance data is generated, access to a given database is obtained. In one embodiment, access to the database is obtained using a data classification discovery agent. In one embodiment, the data classification discovery agent is implemented as code designed to provide access to the databases either via standard communications channels or special database access communication channels.

Returning to FIG. 2, agent 207 is shown as being used to access database 107 and agent 209 is shown as being used to access virtual database asset 139.

Methods, means, processes, and procedures for obtaining access to a database are known in the art. Consequently, a more detailed discussion of the various specific methods, means, processes, and procedures for obtaining access to the database is omitted here to avoid detracting from the invention.

In one embodiment, once access to the database is obtained, the data included in the database is scanned to determine the various types of data in the database, and/or the various security classifications and security measures applied to the data in the database. In one embodiment, the scan of the data in the database is performed using the data classification discovery agent. In one embodiment, the data classification discovery agent is used to read the various columns and rows of the data schema used within the database to store data.

Returning to FIG. 2, agent 207 is shown as being used to access database 107 and scan highly sensitive data 107H and less sensitive data 107L of database 107. In one embodiment, agent 207 thereby obtains/generates data type/classification data 207 indicating the various types of data in database 107, and/or the various security classifications and security measures applied to the data in the database 107.

Likewise, in FIG. 2 agent 209 is shown as being used to access virtual database asset 139 and scan the data associated with virtual database asset 139. In one embodiment, agent 209 thereby obtains/generates data type/classification data 219 indicating the various types of data associated with virtual database asset 139 and/or the various security classifications and security measures applied to the data associated with virtual database asset 139.

In one embodiment, if during the scan of the data in the database, a data type, and/or security classification, associated with any portion of the data in the database cannot be determined, a prompt is provided to the owner of the database to provide information indicating the type, and/or data security classification, of that portion of the data in the database. In one embodiment, if a data type, and/or security classification, associated with any portion of the data in the database cannot be determined, and/or there is no response to the prompt to provide the data type, and/or security classification, associated with the portion of the data, that portion of the data is, as a default, determined to be of the highest sensitivity type, and therefore requiring the highest data security type classification and levels of protection.

In one embodiment, data type/security classification data for each type of data in the database is recorded. In one embodiment, the data type/security classification data associated with the database is then used to determine a database security classification to be applied to the database. In other words, in one embodiment a database security classification to be applied to the entire database is determined based, at least in part, on the determined types of data, and/or data security classifications of the data, in the database.

In one embodiment, database security classification data for the database is then generated representing, in machine readable form, the determined database security classification to be applied to the entire database. In one embodiment, the database security classification for the database is associated with the database. In one embodiment, the database security classification for the database is associated with the database by generating metadata for the database representing the database security classification for the database.

Returning to FIG. 2, agent 207 obtains/generates data type/classification data 207 indicating the various types of data in database 107, and/or the various security classifications and security measures applied to the data in the database 107. In one embodiment, data type/classification data 207 is provided to data type/classification and database security classification matching engine 203. In one embodiment, at data type/classification and database security classification matching engine 203, security data type/classification data 207 is matched with one of the database security classifications, e.g., database security classification A or database security classification B, of database security classification types data 205. In one embodiment, once data type/classification data 207 is matched, in this specific illustrative example, to database security classification A of database security classification types data 205, data indicating database security classification A is associated with database 107 is generated, indicated by the presence of database security classification A in database 107.

As also seen in FIG. 2, agent 209 obtains/generates data type/classification data 219 indicating the various types of data associated with virtual database asset 139, and/or the various security classifications and security measures applied to the data associated with virtual database asset 139. In one embodiment, data type/classification data 219 is provided to data type/classification and database security classification matching engine 203. In one embodiment, at data type/classification and database security classification matching engine 203, security data type/classification data 219 is matched with one of the database security classifications, e.g., database security classification A or database security classification B, of database security classification types data 205. In one embodiment, once data type/classification data 219 is matched, in this specific illustrative example, to database security classification B of database security classification types data 205, data indicating database security classification B is associated with virtual database asset 139 is generated, indicated by the presence of database security classification B in virtual database asset 139.

In one embodiment, once the database security classification for the database is determined and database security classification data for the database is associated with the database, the database security policy compliance data is analyzed to determine what security measures of the security policy compliance data should be applied to the database based on the database security classification for the database. In other words, in one embodiment, the database security classification for the database is used to determine which database security measures of the database security policy compliance data must be applied to the database in order to ensure compliance with the data security policies.

Returning to FIG. 2, in one embodiment, once data type/classification data 207 is matched, in this specific illustrative example, to database security classification A of database security classification types data 205, and data indicating database security classification A is associated with database 107 is generated, data indicating database security classification A is provided to database security classification and database security measures matching engine 211. In one embodiment, database security classification and database security measures matching engine 211 matches the data indicating database security classification A for database 107 to database security measures A of database security policy compliance data 201. Consequently, it is determined that instructions for implementing database security measures A of database security policy compliance data 201 should be applied to database 107.

Likewise, as shown in FIG. 2, in one embodiment, once data type/classification data 219 is matched, in this specific illustrative example, to database security classification B of database security classification types data 205, and data indicating database security classification B is associated with virtual database asset 139 is generated, data indicating database security classification B is provided to database security classification and database security measures matching engine 211. In one embodiment, database security classification and database security measures matching engine 211 matches the data indicating database security classification B for virtual database asset 139 to database security measures B of database security policy compliance data 201. Consequently, it is determined that instructions for implementing database security measures B of database security policy compliance data 201 should be applied to virtual database asset 139.

In one embodiment, once the security measures of the security policy compliance data required to ensure compliance of the database with the data security policies are determined, these security measures are automatically applied to the database at the database level.

Returning to FIG. 2, once it is determined that instructions for implementing database security measures A of database security policy compliance data 201 should be applied to database 107, database security measures A of database security policy compliance data 201 are automatically applied to database 107; in one embodiment, on a continuing basis as needed.

As also seen in FIG. 2, once it is determined that instructions for implementing database security measures B of database security policy compliance data 201 should be applied to virtual database asset 139, database security measures B of database security policy compliance data 201 are automatically applied to virtual database asset 139; in one embodiment, on a continuing basis as needed.

Using the above-described embodiment of the method and system for implementing data security policies using database classification, data security policy is implemented at the individual database level. As a result, data security policies can be readily applied to individual databases in a highly flexible and dynamic manner.

Consequently, the above-described embodiment of the method and system for implementing data security policies using database classification provides the flexibility needed to readily adapt to the dynamic nature of a cloud computing environment, or any computing environment where the type and number of assets, e.g., databases, is capable of rapidly changing. In addition, using the above-described embodiment of the method and system for implementing data security policies using database classification, the data security policies are implemented locally, at the individual database level, so that a user of the data, such as an application developer, is not aware of the implementation of the security policy, e.g. the data security policy is applied at the individual database level in a symmetrically transparent manner, leaving the user with an experience similar to that of storing all data as plain text data.

In accordance with one embodiment, one or more data security policies to be applied to data are defined. In one embodiment, the one or more data security policies are defined by the owners of the data stored in the databases. In other embodiments, the one or more data security policies are defined by one or more of, the provider of the production environment, the provider or developer of an application, the provider of a cloud computing infrastructure, and/or any other parties or entities, as discussed herein, and/or as known in the art at the time of filing, and/or as become known after the time of filing.

As specific illustrative examples, in various embodiments, the data security policies include, but are not limited to, one or more data security policies requiring specific encryption, or a defined level of encryption, for data; one or more data security policies requiring the use of tokens or tokenization of data; one or more data security policies requiring hashes, and/or one-way hashes, of data; one or more data security policies requiring log records be kept tracking all modifications to data; one or more data security policies requiring the logging of all access, or attempts to access, the data; one or more data security policies requiring all access to the data be authenticated; one or more data security policies requiring specific identification/authentication procedures, such as mandatory multifactor authentication; one or more data security policies requiring all access to the data be associated with authorized roles; one or more data security policies requiring the logging of various access, or attempts to access, the data; one or more data security policies requiring the logging of various processing, or attempts to process or manipulate, the data; one or more data security policies delineating the protective actions to be applied to the data in the event of a generalized or specific security event; and/or any other data security policies, or combination of security policies, as discussed herein, and/or as known in the art at the time of filing, and/or as become known in the art after the time of filing.

In one embodiment, once the data security policies to be applied to data are defined, data security policy compliance data representing instructions for applying one or more data security measures to data in databases in order to ensure compliance of the data in the databases with the one or more data security policies, at the data level, is generated. In one embodiment, each of the one or more security measures is associated with a different data security classification.

Consequently, in one embodiment, the data security policy compliance data represents, or includes, instructions for applying one or more data security measures to data that include, but are not limited to, applying specific encryption, or a defined level of encryption, for the data; the use of tokens or tokenization of data; applying hashes and/or one-way hashes of data; logging all modifications to data; logging all access, or attempts to access, the data; requiring all access to the data be authenticated; implementing specific identification/authentication procedures, such as mandatory multifactor authentication; requiring that all access to the data be associated with authorized roles; logging specific types of access, or attempts to access, the data; logging various processing, or attempts to process or manipulate, the data; applying one or more protective actions to the data in the event of a generalized or specific security event; and/or any other data security policy compliance data deemed necessary to ensure conformance with the data security policies, as discussed herein, and/or as known in the art at the time of filing, and/or as become known in the art after the time of filing.

In one embodiment, database security policy compliance data is also generated. In one embodiment, the database security policy compliance data represents, or includes, instructions for applying one or more database security measures to databases containing data in order to ensure compliance of the databases with the one or more data security policies at the database level. In one embodiment, each of the one or more database security measures is associated with a different database security classification, calculated as discussed below.

Consequently, in one embodiment, the database security policy compliance data represents, or includes, instructions for applying one or more database security measures to databases containing data that include, but are not limited to, applying specific encryption, or a defined level of encryption, for the entire databases; the use of tokens or tokenization of data in the databases; applying hashes and/or one-way hashes of data in the databases; logging all modifications to data in the databases; logging all access, or attempts to access, the data in the databases; requiring all access to the data in the databases be authenticated; implementing specific identification/authentication procedures, such as mandatory multifactor authentication; requiring that all access to the databases be associated with authorized roles; logging specific types of access, or attempts to access, the data in the databases; logging various processing, or attempts to process or manipulate, the data in the databases; applying one or more protective actions to the databases in the event of a generalized or specific security event; and/or any other database security policy compliance data deemed necessary to ensure database conformance with the data security policies, as discussed herein, and/or as known in the art at the time of filing, and/or as become known in the art after the time of filing.

In one embodiment, once the database security policy compliance data is generated, access to a given database is obtained. In one embodiment, access to the database is obtained using a data classification discovery agent. In one embodiment, the data classification discovery agent is implemented as code designed to provide access to the databases either via standard communications channels or special database access communication channels.

In one embodiment, once access to the database is obtained, the data in the database is scanned to determine the various types of data in the database, and/or the various security classifications, and the security measures applied to each type of data in the database. In one embodiment, the security measures applied to each type of data in the database are analyzed to determine if the security measures applied to the data, at the data level, is in compliance with the data security policies. In one embodiment, if a determination is made that the security measures applied to the data, at the data level, are not in compliance with the data security policies, the data security policy compliance data is used to apply the correct security measures to obtain conformance with the one or more data security policies.

In one embodiment, if during the scan of the data in the database, a data type, and/or security classification, associated with any portion of the data in the database cannot be determined, a prompt is provided to the owner of the database to provide information indicating the type, and/or data security classification, of that portion of the data in the database. In one embodiment, if a data type, and/or security classification, associated with any portion of the data in the database cannot be determined, and/or there is no response to the prompt to provide the data type, and/or security classification, associated with a portion of the data, that portion of the data is, as a default, determined to be of the highest sensitivity type, and therefore requiring the highest levels of protection.

In one embodiment, once the data included in the database is scanned to determine the various types of data in the database, and/or the various security classifications and security measures applied to the data in the database, data type/security classification data for each type of data in the database is recorded. In one embodiment, the data type/security classification data associated with the database is then used to determine a database security classification to be applied to the entire database. In other words, in one embodiment a database security classification to be applied to the entire database is determined based, at least in part, on the determined types of data, and/or data security classifications of the data, in the database.

In one embodiment, database security classification data for the database is then generated representing, in machine readable form, the determined database security classification to be applied to the entire database. In one embodiment, the database security classification for the database is associated with the database. In one embodiment, the database security classification for the database is associated with the database by generating metadata for the database representing the database security classification for the database.

In one embodiment, once the database security classification for the database is determined and database security classification data for the database is associated with the database, the database security policy compliance data is analyzed to determine what security measures of the security policy compliance data should be applied to the database based on the database security classification for the database. In other words, in one embodiment, the database security classification for the database is used to determine which security measures of the security policy compliance data must be applied to the database in order to ensure compliance with the data security policies.

In one embodiment, once the security measures of the security policy compliance data required to ensure compliance of the database with the data security policies are determined, these security measures are automatically applied to the database at the database level.

Using the above-described embodiment of the method and system for implementing data security policies using database classification, data security policy is implemented at both the data level and the individual database level. As a result, data security policies can be readily applied to data in individual databases in a highly flexible and dynamic manner.

Consequently, the above-described embodiment of the method and system for implementing data security policies using database classification provides the flexibility needed to readily adapt to the dynamic nature of a cloud computing environment, or any computing environment where the type and number of assets, e.g., databases, is capable of rapidly changing. In addition, using the above-described embodiment of the method and system for implementing data security policies using database classification, the data security policies are implemented locally, at the individual database level, so that a user of the data, such as an application developer, is not aware of the implementation of the security policy, e.g. the data security policy is applied at the individual database level in a symmetrically transparent manner, leaving the user with an experience similar to that of storing all data as plain text data.

### Process

In one embodiment, a process for implementing data security policies using database classification includes defining one or more data security policies to be applied to data. In one embodiment, database security policy compliance data is generated that represents instructions for applying one or more database security measures to databases containing data in order to ensure compliance of the databases, and data therein, with the one or more data security policies. In one embodiment, each of the one or more database security measures is associated with a different database security classification.

In one embodiment, access to a database is obtained, the database containing data that is potentially of one or more data types, and/or data security classifications. In one embodiment, the data in the database is scanned to determine the types of data, and/or data security classifications of the data, in the database. In one embodiment, based, at least in part, on the determined types of data, and/or data security classifications of the data, in the database, a database security classification to be applied to the entire database is determined. Database security classification data for the database indicating the database security classification to be applied to the database is then generated. In one embodiment, the database security classification data for the database is associated with the database and is then used to select one or more database security measures of the database security policy compliance data to be applied to the database.

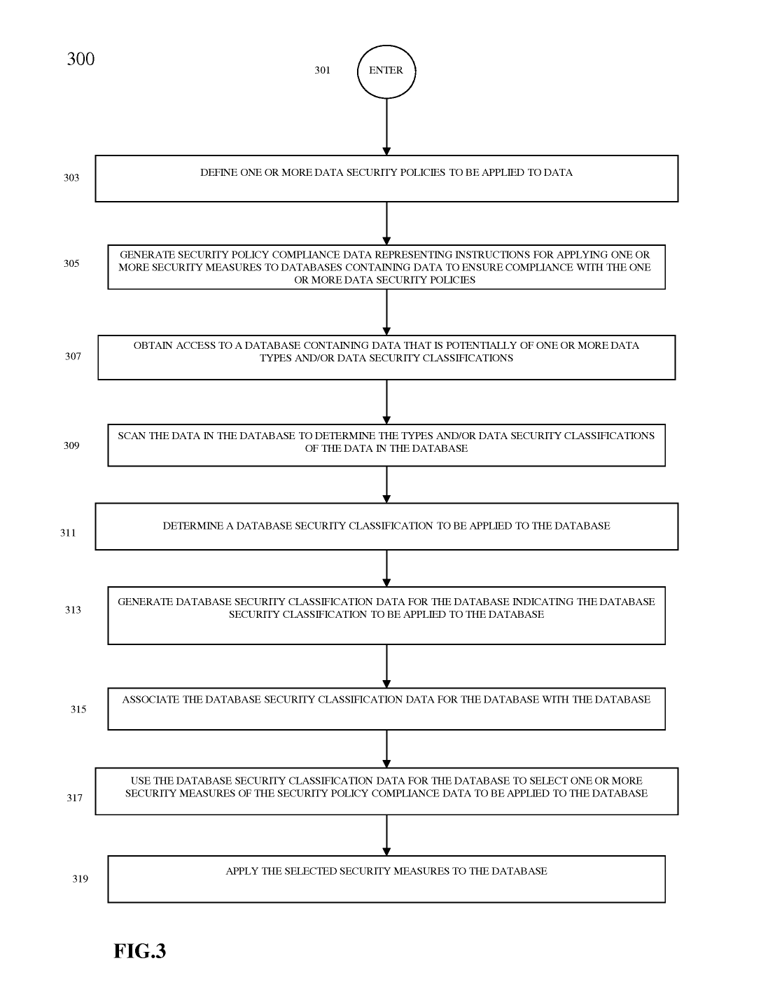

FIG. 3 is a flow chart of a process 300 for implementing data security policies using database classification in accordance with one embodiment. In one embodiment, process 300 for implementing data security policies using database classification begins at ENTER OPERATION 301 of FIG. 3 and process flow proceeds to DEFINE ONE OR MORE DATA SECURITY POLICIES TO BE APPLIED TO DATA OPERATION 303.

In one embodiment, at DEFINE ONE OR MORE DATA SECURITY POLICIES TO BE APPLIED TO DATA OPERATION 303 one or more data security policies to be applied to data are defined.

In one embodiment, the one or more data security policies are defined at DEFINE ONE OR MORE DATA SECURITY POLICIES TO BE APPLIED TO DATA OPERATION 303 by the owners of the data to be stored in the databases. In other embodiments, the one or more data security policies are defined at DEFINE ONE OR MORE DATA SECURITY POLICIES TO BE APPLIED TO DATA OPERATION 303 by one or more of, the provider of the production environment, the provider or developer of an application, the provider of a cloud computing infrastructure, and/or any other parties or entities, as discussed herein, and/or as known in the art at the time of filing, and/or as become known after the time of filing.

As specific illustrative examples, in various embodiments, the data security policies of DEFINE ONE OR MORE DATA SECURITY POLICIES TO BE APPLIED TO DATA OPERATION 303 include, but are not limited to, one or more data security policies requiring specific encryption, or a defined level of encryption, for data; one or more data security policies requiring the use of tokens or tokenization of data; one or more data security policies requiring hashes, and/or one-way hashes, of data; one or more data security policies requiring log records be kept tracking all modifications to data; one or more data security policies requiring the logging of all access, or attempts to access, the data; one or more data security policies requiring all access to the data be authenticated; one or more data security policies requiring specific identification/authentication procedures, such as mandatory multifactor authentication; one or more data security policies requiring all access to the data be associated with authorized roles; one or more data security policies requiring the logging of various access, or attempts to access, the data; one or more data security policies requiring the logging of various processing, or attempts to process or manipulate, the data; one or more data security policies delineating the protective actions to be applied to the data in the event of a generalized or specific security event; and/or any other data security policies, or combination of security policies, as discussed herein, and/or as known in the art at the time of filing, and/or as become known in the art after the time of filing.

In one embodiment, once one or more data security policies to be applied to data are defined at DEFINE ONE OR MORE DATA SECURITY POLICIES TO BE APPLIED TO DATA OPERATION 303, process flow proceeds to GENERATE SECURITY POLICY COMPLIANCE DATA REPRESENTING INSTRUCTIONS FOR APPLYING ONE OR MORE SECURITY MEASURES TO DATABASES CONTAINING DATA TO ENSURE COMPLIANCE WITH THE ONE OR MORE DATA SECURITY POLICIES OPERATION 305.

In one embodiment, at GENERATE SECURITY POLICY COMPLIANCE DATA REPRESENTING INSTRUCTIONS FOR APPLYING ONE OR MORE SECURITY MEASURES TO DATABASES CONTAINING DATA TO ENSURE COMPLIANCE WITH THE ONE OR MORE DATA SECURITY POLICIES OPERATION 305 database security policy compliance data associated with the security policies of DEFINE ONE OR MORE DATA SECURITY POLICIES TO BE APPLIED TO DATA OPERATION 303 is generated.

In one embodiment, the database security policy compliance data of GENERATE SECURITY POLICY COMPLIANCE DATA REPRESENTING INSTRUCTIONS FOR APPLYING ONE OR MORE SECURITY MEASURES TO DATABASES CONTAINING DATA TO ENSURE COMPLIANCE WITH THE ONE OR MORE DATA SECURITY POLICIES OPERATION 305 represents, or includes, instructions for applying one or more database security measures to databases containing data in order to ensure compliance of the databases with the one or more data security policies of DEFINE ONE OR MORE DATA SECURITY POLICIES TO BE APPLIED TO DATA OPERATION 303 at the database level. In one embodiment, each of the one or more database security measures of GENERATE SECURITY POLICY COMPLIANCE DATA REPRESENTING INSTRUCTIONS FOR APPLYING ONE OR MORE SECURITY MEASURES TO DATABASES CONTAINING DATA TO ENSURE COMPLIANCE WITH THE ONE OR MORE DATA SECURITY POLICIES OPERATION 305 is associated with a different database security classification, calculated as discussed below.

Consequently, in one embodiment, the database security policy compliance data of GENERATE SECURITY POLICY COMPLIANCE DATA REPRESENTING INSTRUCTIONS FOR APPLYING ONE OR MORE SECURITY MEASURES TO DATABASES CONTAINING DATA TO ENSURE COMPLIANCE WITH THE ONE OR MORE DATA SECURITY POLICIES OPERATION 305 represents, or includes, instructions for applying one or more database security measures to databases containing data that include, but are not limited to, applying specific encryption, or a defined level of encryption, for the entire databases; the use of tokens or tokenization of data in the databases; applying hashes and/or one-way hashes of data in the databases; logging all modifications to data in the databases; logging all access, or attempts to access, the data in the databases; requiring all access to the data in the databases be authenticated; implementing specific identification/authentication procedures, such as mandatory multifactor authentication; requiring that all access to the databases be associated with authorized roles; logging specific types of access, or attempts to access, the data in the databases; logging various processing, or attempts to process or manipulate, the data in the databases; applying one or more protective actions to the databases in the event of a generalized or specific security event; and/or any other database security policy compliance data deemed necessary to ensure database conformance with the data security policies, as discussed herein, and/or as known in the art at the time of filing, and/or as become known in the art after the time of filing.

In one embodiment, once database security policy compliance data associated with the security policies of DEFINE ONE OR MORE DATA SECURITY POLICIES TO BE APPLIED TO DATA OPERATION 303 is generated at GENERATE SECURITY POLICY COMPLIANCE DATA REPRESENTING INSTRUCTIONS FOR APPLYING ONE OR MORE SECURITY MEASURES TO DATABASES CONTAINING DATA TO ENSURE COMPLIANCE WITH THE ONE OR MORE DATA SECURITY POLICIES OPERATION 305, process flow proceeds to OBTAIN ACCESS TO A DATABASE CONTAINING DATA THAT IS POTENTIALLY OF ONE OR MORE DATA TYPES AND/OR DATA SECURITY CLASSIFICATIONS OPERATION 307.

In one embodiment, at OBTAIN ACCESS TO A DATABASE CONTAINING DATA THAT IS POTENTIALLY OF ONE OR MORE DATA TYPES AND/OR DATA SECURITY CLASSIFICATIONS OPERATION 307, access to a database is obtained.

In one embodiment, at OBTAIN ACCESS TO A DATABASE CONTAINING DATA THAT IS POTENTIALLY OF ONE OR MORE DATA TYPES AND/OR DATA SECURITY CLASSIFICATIONS OPERATION 307, access to a database is obtained using a data classification discovery agent. In one embodiment, the data classification discovery agent is implemented as code designed to provide access to the databases either via standard communications channels or special database access communication channels.

Methods, means, processes, and procedures for obtaining access to database are known in the art. Consequently, a more detailed discussion of the various specific methods, means, processes, and procedures for obtaining access to the database is omitted here to avoid detracting from the invention.

In one embodiment, once access to a database is obtained at OBTAIN ACCESS TO A DATABASE CONTAINING DATA THAT IS POTENTIALLY OF ONE OR MORE DATA TYPES AND/OR DATA SECURITY CLASSIFICATIONS OPERATION 307, process flow proceeds to SCAN THE DATA IN THE DATABASE TO DETERMINE THE TYPES AND/OR DATA SECURITY CLASSIFICATIONS OF THE DATA IN THE DATABASE OPERATION 309.

In one embodiment, at SCAN THE DATA IN THE DATABASE TO DETERMINE THE TYPES AND/OR DATA SECURITY CLASSIFICATIONS OF THE DATA IN THE DATABASE OPERATION 309, the data included in the database of OBTAIN ACCESS TO A DATABASE CONTAINING DATA THAT IS POTENTIALLY OF ONE OR MORE DATA TYPES AND/OR DATA SECURITY CLASSIFICATIONS OPERATION 307 is scanned to determine the various types of data in the database, and/or the various security classifications and security measures applied to the data in the database.

In one embodiment, the scan of the data in the database is performed at SCAN THE DATA IN THE DATABASE TO DETERMINE THE TYPES AND/OR DATA SECURITY CLASSIFICATIONS OF THE DATA IN THE DATABASE OPERATION 309 using the data classification discovery agent. In one embodiment, at SCAN THE DATA IN THE DATABASE TO DETERMINE THE TYPES AND/OR DATA SECURITY CLASSIFICATIONS OF THE DATA IN THE DATABASE OPERATION 309 the data classification discovery agent is used to read the various columns and rows of the data schema used within the database to store data.

In one embodiment, if during the scan of the data in the database at SCAN THE DATA IN THE DATABASE TO DETERMINE THE TYPES AND/OR DATA SECURITY CLASSIFICATIONS OF THE DATA IN THE DATABASE OPERATION 309, a data type, and/or security classification, associated with any portion of the data in the database cannot be determined, a prompt is provided to the owner of the database to provide information indicating the type, and/or data security classification, of that portion of the data in the database.

In one embodiment, if a data type, and/or security classification, associated with any portion of the data in the database cannot be determined at SCAN THE DATA IN THE DATABASE TO DETERMINE THE TYPES AND/OR DATA SECURITY CLASSIFICATIONS OF THE DATA IN THE DATABASE OPERATION 309, and/or there is no response to the prompt to provide the data type, and/or security classification, associated with a portion of the data, that portion of the data is, as a default, determined to be of the highest sensitivity type, and therefore requiring the highest levels of protection.

In one embodiment, once the data included in the database of OBTAIN ACCESS TO A DATABASE CONTAINING DATA THAT IS POTENTIALLY OF ONE OR MORE DATA TYPES AND/OR DATA SECURITY CLASSIFICATIONS OPERATION 307 is scanned to determine the various types of data in the database, and/or the various security classifications and security measures applied to the data in the database at SCAN THE DATA IN THE DATABASE TO DETERMINE THE TYPES AND/OR DATA SECURITY CLASSIFICATIONS OF THE DATA IN THE DATABASE OPERATION 309, process flow proceeds to DETERMINE A DATABASE SECURITY CLASSIFICATION TO BE APPLIED TO THE DATABASE OPERATION 311.

In one embodiment, at DETERMINE A DATABASE SECURITY CLASSIFICATION TO BE APPLIED TO THE DATABASE OPERATION 311, the data type/security classification data associated with the database determined at SCAN THE DATA IN THE DATABASE TO DETERMINE THE TYPES AND/OR DATA SECURITY CLASSIFICATIONS OF THE DATA IN THE DATABASE OPERATION 309 is used to determine a database security classification to be applied to the entire database of OBTAIN ACCESS TO A DATABASE CONTAINING DATA THAT IS POTENTIALLY OF ONE OR MORE DATA TYPES AND/OR DATA SECURITY CLASSIFICATIONS OPERATION 307.

In one embodiment, as a result of the scan at SCAN THE DATA IN THE DATABASE TO DETERMINE THE TYPES AND/OR DATA SECURITY CLASSIFICATIONS OF THE DATA IN THE DATABASE OPERATION 309 data type/security classification data for each type of data in the database of OBTAIN ACCESS TO A DATABASE CONTAINING DATA THAT IS POTENTIALLY OF ONE OR MORE DATA TYPES AND/OR DATA SECURITY CLASSIFICATIONS OPERATION 307 is recorded. In one embodiment, at DETERMINE A DATABASE SECURITY CLASSIFICATION TO BE APPLIED TO THE DATABASE OPERATION 311 the data type/security classification data associated with the database is then used to determine a database security classification to be applied to the entire database. In other words, in one embodiment, at DETERMINE A DATABASE SECURITY CLASSIFICATION TO BE APPLIED TO THE DATABASE OPERATION 311, a database security classification to be applied to the entire database is determined based, at least in part, on the determined types of data, and/or data security classifications of the data, in the database.

In one embodiment, once the data type/security classification data associated with the database determined at SCAN THE DATA IN THE DATABASE TO DETERMINE THE TYPES AND/OR DATA SECURITY CLASSIFICATIONS OF THE DATA IN THE DATABASE OPERATION 309 is used to determine a database security classification to be applied to the entire database of OBTAIN ACCESS TO A DATABASE CONTAINING DATA THAT IS POTENTIALLY OF ONE OR MORE DATA TYPES AND/OR DATA SECURITY CLASSIFICATIONS OPERATION 307 at DETERMINE A DATABASE SECURITY CLASSIFICATION TO BE APPLIED TO THE DATABASE OPERATION 311, process flow proceeds to GENERATE DATABASE SECURITY CLASSIFICATION DATA FOR THE DATABASE INDICATING THE DATABASE SECURITY CLASSIFICATION TO BE APPLIED TO THE DATABASE OPERATION 313.

In one embodiment, at GENERATE DATABASE SECURITY CLASSIFICATION DATA FOR THE DATABASE INDICATING THE DATABASE SECURITY CLASSIFICATION TO BE APPLIED TO THE DATABASE OPERATION 313, database security classification data for the database of OBTAIN ACCESS TO A DATABASE CONTAINING DATA THAT IS POTENTIALLY OF ONE OR MORE DATA TYPES AND/OR DATA SECURITY CLASSIFICATIONS OPERATION 307 is generated representing, in machine readable form, the determined database security classification to be applied to the entire database of DETERMINE A DATABASE SECURITY CLASSIFICATION TO BE APPLIED TO THE DATABASE OPERATION 311.

In one embodiment, once database security classification data for the database of OBTAIN ACCESS TO A DATABASE CONTAINING DATA THAT IS POTENTIALLY OF ONE OR MORE DATA TYPES AND/OR DATA SECURITY CLASSIFICATIONS OPERATION 307 is generated representing, in machine readable form, the determined database security classification to be applied to the entire database of DETERMINE A DATABASE SECURITY CLASSIFICATION TO BE APPLIED TO THE DATABASE OPERATION 311 at GENERATE DATABASE SECURITY CLASSIFICATION DATA FOR THE DATABASE INDICATING THE DATABASE SECURITY CLASSIFICATION TO BE APPLIED TO THE DATABASE OPERATION 313, process flow proceeds to ASSOCIATE THE DATABASE SECURITY CLASSIFICATION DATA FOR THE DATABASE WITH THE DATABASE OPERATION 315.

In one embodiment, at ASSOCIATE THE DATABASE SECURITY CLASSIFICATION DATA FOR THE DATABASE WITH THE DATABASE OPERATION 315, the database security classification for the database of GENERATE DATABASE SECURITY CLASSIFICATION DATA FOR THE DATABASE INDICATING THE DATABASE SECURITY CLASSIFICATION TO BE APPLIED TO THE DATABASE OPERATION 313 is associated with the entire database of OBTAIN ACCESS TO A DATABASE CONTAINING DATA THAT IS POTENTIALLY OF ONE OR MORE DATA TYPES AND/OR DATA SECURITY CLASSIFICATIONS OPERATION 307.

In one embodiment, the database security classification for the database is associated with the database at ASSOCIATE THE DATABASE SECURITY CLASSIFICATION DATA FOR THE DATABASE WITH THE DATABASE OPERATION 315 by generating metadata for the database representing the database security classification for the database.

In one embodiment, once the database security classification for the database of GENERATE DATABASE SECURITY CLASSIFICATION DATA FOR THE DATABASE INDICATING THE DATABASE SECURITY CLASSIFICATION TO BE APPLIED TO THE DATABASE OPERATION 313 is associated with the entire database of OBTAIN ACCESS TO A DATABASE CONTAINING DATA THAT IS POTENTIALLY OF ONE OR MORE DATA TYPES AND/OR DATA SECURITY CLASSIFICATIONS OPERATION 307 at ASSOCIATE THE DATABASE SECURITY CLASSIFICATION DATA FOR THE DATABASE WITH THE DATABASE OPERATION 315, process flow proceeds to USE THE DATABASE SECURITY CLASSIFICATION DATA FOR THE DATABASE TO SELECT ONE OR MORE SECURITY MEASURES OF THE SECURITY POLICY COMPLIANCE DATA TO BE APPLIED TO THE DATABASE OPERATION 317.

In one embodiment, at USE THE DATABASE SECURITY CLASSIFICATION DATA FOR THE DATABASE TO SELECT ONE OR MORE SECURITY MEASURES OF THE SECURITY POLICY COMPLIANCE DATA TO BE APPLIED TO THE DATABASE OPERATION 317 the database security classification associated with the database of OBTAIN ACCESS TO A DATABASE CONTAINING DATA THAT IS POTENTIALLY OF ONE OR MORE DATA TYPES AND/OR DATA SECURITY CLASSIFICATIONS OPERATION 307 at ASSOCIATE THE DATABASE SECURITY CLASSIFICATION DATA FOR THE DATABASE WITH THE DATABASE OPERATION 315 is used to determine what security measures of the security policy compliance data of GENERATE SECURITY POLICY COMPLIANCE DATA REPRESENTING INSTRUCTIONS FOR APPLYING ONE OR MORE SECURITY MEASURES TO DATABASES CONTAINING DATA TO ENSURE COMPLIANCE WITH THE ONE OR MORE DATA SECURITY POLICIES OPERATION 305 should be applied to the database.

As noted above, in one embodiment, the database security policy compliance data of GENERATE SECURITY POLICY COMPLIANCE DATA REPRESENTING INSTRUCTIONS FOR APPLYING ONE OR MORE SECURITY MEASURES TO DATABASES CONTAINING DATA TO ENSURE COMPLIANCE WITH THE ONE OR MORE DATA SECURITY POLICIES OPERATION 305 represents, or includes, instructions for applying one or more database security measures to databases containing data in order to ensure compliance of the databases with the one or more data security policies of DEFINE ONE OR MORE DATA SECURITY POLICIES TO BE APPLIED TO DATA OPERATION 303 at the database level.

As also noted above, in one embodiment, each of the one or more database security measures of GENERATE SECURITY POLICY COMPLIANCE DATA REPRESENTING INSTRUCTIONS FOR APPLYING ONE OR MORE SECURITY MEASURES TO DATABASES CONTAINING DATA TO ENSURE COMPLIANCE WITH THE ONE OR MORE DATA SECURITY POLICIES OPERATION 305 is associated with a different database security classification of ASSOCIATE THE DATABASE SECURITY CLASSIFICATION DATA FOR THE DATABASE WITH THE DATABASE OPERATION 315.

Consequently, in one embodiment, at USE THE DATABASE SECURITY CLASSIFICATION DATA FOR THE DATABASE TO SELECT ONE OR MORE SECURITY MEASURES OF THE SECURITY POLICY COMPLIANCE DATA TO BE APPLIED TO THE DATABASE OPERATION 317 the database security classification associated with the database of OBTAIN ACCESS TO A DATABASE CONTAINING DATA THAT IS POTENTIALLY OF ONE OR MORE DATA TYPES AND/OR DATA SECURITY CLASSIFICATIONS OPERATION 307 at ASSOCIATE THE DATABASE SECURITY CLASSIFICATION DATA FOR THE DATABASE WITH THE DATABASE OPERATION 315 is mapped to the security measures of the security policy compliance data of GENERATE SECURITY POLICY COMPLIANCE DATA REPRESENTING INSTRUCTIONS FOR APPLYING ONE OR MORE SECURITY MEASURES TO DATABASES CONTAINING DATA TO ENSURE COMPLIANCE WITH THE ONE OR MORE DATA SECURITY POLICIES OPERATION 305 corresponding to the database security classification associated with the database of OBTAIN ACCESS TO A DATABASE CONTAINING DATA THAT IS POTENTIALLY OF ONE OR MORE DATA TYPES AND/OR DATA SECURITY CLASSIFICATIONS OPERATION 307.

In other words, in one embodiment, the database security classification for the database is used to determine which security measures of the security policy compliance data must be applied to the database in order to ensure compliance with the data security policies.

In one embodiment, once the database security classification associated with the database of OBTAIN ACCESS TO A DATABASE CONTAINING DATA THAT IS POTENTIALLY OF ONE OR MORE DATA TYPES AND/OR DATA SECURITY CLASSIFICATIONS OPERATION 307 at ASSOCIATE THE DATABASE SECURITY CLASSIFICATION DATA FOR THE DATABASE WITH THE DATABASE OPERATION 315 is used to determine what security measures of the security policy compliance data of GENERATE SECURITY POLICY COMPLIANCE DATA REPRESENTING INSTRUCTIONS FOR APPLYING ONE OR MORE SECURITY MEASURES TO DATABASES CONTAINING DATA TO ENSURE COMPLIANCE WITH THE ONE OR MORE DATA SECURITY POLICIES OPERATION 305 should be applied to the database at USE THE DATABASE SECURITY CLASSIFICATION DATA FOR THE DATABASE TO SELECT ONE OR MORE SECURITY MEASURES OF THE SECURITY POLICY COMPLIANCE DATA TO BE APPLIED TO THE DATABASE OPERATION 317, process flow proceeds to APPLY THE SELECTED SECURITY MEASURES TO THE DATABASE OPERATION 319.

In one embodiment, at APPLY THE SELECTED SECURITY MEASURES TO THE DATABASE OPERATION 319, the security measures of USE THE DATABASE SECURITY CLASSIFICATION DATA FOR THE DATABASE TO SELECT ONE OR MORE SECURITY MEASURES OF THE SECURITY POLICY COMPLIANCE DATA TO BE APPLIED TO THE DATABASE OPERATION 317 are automatically applied to the database of OBTAIN ACCESS TO A DATABASE CONTAINING DATA THAT IS POTENTIALLY OF ONE OR MORE DATA TYPES AND/OR DATA SECURITY CLASSIFICATIONS OPERATION 307, at the individual database level.

In one embodiment, once the security measures of USE THE DATABASE SECURITY CLASSIFICATION DATA FOR THE DATABASE TO SELECT ONE OR MORE SECURITY MEASURES OF THE SECURITY POLICY COMPLIANCE DATA TO BE APPLIED TO THE DATABASE OPERATION 317 are automatically applied to the database of OBTAIN ACCESS TO A DATABASE CONTAINING DATA THAT IS POTENTIALLY OF ONE OR MORE DATA TYPES AND/OR DATA SECURITY CLASSIFICATIONS OPERATION 307, at the database level at APPLY THE SELECTED SECURITY MEASURES TO THE DATABASE OPERATION 319, process flow proceeds to EXIT OPERATION 330.

In one embodiment, at EXIT OPERATION 330 process 300 for implementing data security policies using database classification is exited to await new data.

Using process 300 for implementing data security policies using database classification, data security policy is implemented at the individual database level. As a result, data security policies can be readily applied to individual databases in a highly flexible and dynamic manner.

Consequently, process 300 for implementing data security policies using database classification provides the flexibility needed to readily adapt to the dynamic nature of a cloud computing environment, or any computing environment where the type and number of assets, e.g., databases, is capable of rapidly changing. In addition, using process 300 for implementing data security policies using database classification, the data security policies are implemented locally, at the individual database level, so that a user of the data, such as an application developer, is not aware of the implementation of the security policy, e.g. the data security policy is applied at the individual database level in a symmetrically transparent manner, leaving the user with an experience similar to that of storing all data as plain text data.

In one embodiment, a process for implementing data security policies using database classification includes defining one or more data security policies to be applied to data. In one embodiment, data security policy compliance data representing instructions for applying one or more data security measures to data in databases in order to ensure compliance of the data in the databases with the one or more data security policies is generated. In one embodiment, each of the instructions for applying one or more data security measures is associated with a different data security classification.

In one embodiment, database security policy compliance data representing instructions for applying one or more database security measures to databases containing data in order to ensure compliance of the databases with the one or more database security policies is also generated. In one embodiment, each of the instructions for applying one or more database security measures is associated with a different database security classification.

In one embodiment, access to a database containing data that is potentially of one or more data types, and/or one or more data security classifications, is obtained. In one embodiment, the data in the database is scanned to determine the types of data in the database. In one embodiment, for each type of data determined to be in the database, the data security policy compliance data is used to ensure the security measures applied to the data are in conformance with the one or more data security policies.

In one embodiment, the data in the database is also scanned, as part of the same scan, or in a separate scan, to determine the security classifications and/or security measures applied to the data in the database. In one embodiment, based, at least in part, on the determined security classifications and/or security measures applied to the data in the database, a database security classification to be applied to the entire database is determined. In one embodiment, database security classification data for the database is then generated indicating the database security classification to be applied to the database. The database security classification data is then associated with the database and used to select a set of database security measures of the database security policy compliance data to be applied to the database.

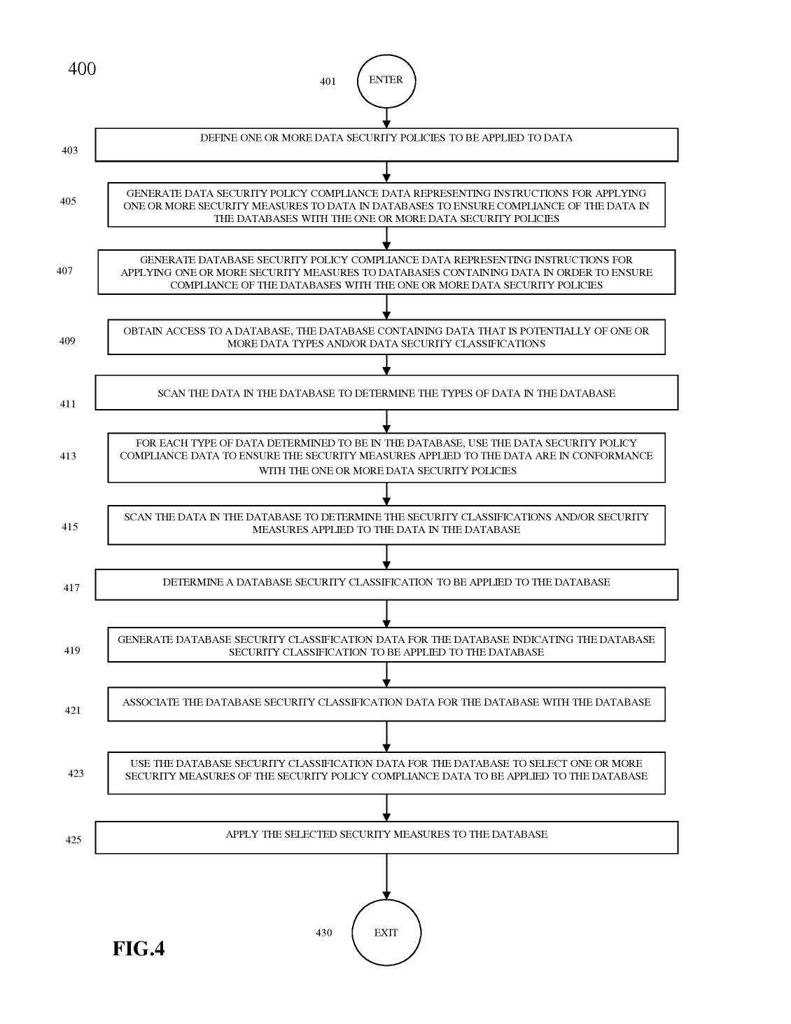

FIG. 4 is a flow chart of a process 400 for implementing data security policies using database classification in accordance with one embodiment. In one embodiment, process 400 for implementing data security policies using database classification begins at ENTER OPERATION 401 of FIG. 4 and process flow proceeds to DEFINE ONE OR MORE DATA SECURITY POLICIES TO BE APPLIED TO DATA OPERATION 403.

In one embodiment, at DEFINE ONE OR MORE DATA SECURITY POLICIES TO BE APPLIED TO DATA OPERATION 403, one or more data security policies to be applied to data are defined.

In one embodiment, the one or more data security policies are defined at DEFINE ONE OR MORE DATA SECURITY POLICIES TO BE APPLIED TO DATA OPERATION 403 by the owners of the data stored in the databases.

In other embodiments, the one or more data security policies are defined at DEFINE ONE OR MORE DATA SECURITY POLICIES TO BE APPLIED TO DATA OPERATION 403 by one or more of, the provider of the production environment, the provider or developer of an application, the provider of a cloud computing infrastructure, and/or any other parties or entities, as discussed herein, and/or as known in the art at the time of filing, and/or as become known after the time of filing.

As specific illustrative examples, in various embodiments, the data security policies of DEFINE ONE OR MORE DATA SECURITY POLICIES TO BE APPLIED TO DATA OPERATION 403, include, but are not limited to, one or more data security policies requiring specific encryption, or a defined level of encryption, for data; one or more data security policies requiring the use of tokens or tokenization of data; one or more data security policies requiring hashes, and/or one-way hashes, of data; one or more data security policies requiring log records be kept tracking all modifications to data; one or more data security policies requiring the logging of all access, or attempts to access, the data; one or more data security policies requiring all access to the data be authenticated; one or more data security policies requiring specific identification/authentication procedures, such as mandatory multifactor authentication; one or more data security policies requiring all access to the data be associated with authorized roles; one or more data security policies requiring the logging of various access, or attempts to access, the data; one or more data security policies requiring the logging of various processing, or attempts to process or manipulate, the data; one or more data security policies delineating the protective actions to be applied to the data in the event of a generalized or specific security event; and/or any other data security policies, or combination of security policies, as discussed herein, and/or as known in the art at the time of filing, and/or as become known in the art after the time of filing.

In one embodiment, once one or more data security policies to be applied to data are defined at DEFINE ONE OR MORE DATA SECURITY POLICIES TO BE APPLIED TO DATA OPERATION 403, process flow proceeds to GENERATE DATA SECURITY POLICY COMPLIANCE DATA REPRESENTING INSTRUCTIONS FOR APPLYING ONE OR MORE SECURITY MEASURES TO DATA IN DATABASES TO ENSURE COMPLIANCE OF THE DATA IN THE DATABASES WITH THE ONE OR MORE DATA SECURITY POLICIES OPERATION 405.

In one embodiment, at GENERATE DATA SECURITY POLICY COMPLIANCE DATA REPRESENTING INSTRUCTIONS FOR APPLYING ONE OR MORE SECURITY MEASURES TO DATA IN DATABASES TO ENSURE COMPLIANCE OF THE DATA IN THE DATABASES WITH THE ONE OR MORE DATA SECURITY POLICIES OPERATION 405, data security policy compliance data representing instructions for applying one or more data security measures to data in databases in order to ensure compliance of the data in the databases with the one or more data security policies of DEFINE ONE OR MORE DATA SECURITY POLICIES TO BE APPLIED TO DATA OPERATION 403, at the data level, is generated.

In one embodiment, each of the one or more security measures of GENERATE DATA SECURITY POLICY COMPLIANCE DATA REPRESENTING INSTRUCTIONS FOR APPLYING ONE OR MORE SECURITY MEASURES TO DATA IN DATABASES TO ENSURE COMPLIANCE OF THE DATA IN THE DATABASES WITH THE ONE OR MORE DATA SECURITY POLICIES OPERATION 405 is associated with a different data security classification.

Consequently, in one embodiment, the data security policy compliance data of GENERATE DATA SECURITY POLICY COMPLIANCE DATA REPRESENTING INSTRUCTIONS FOR APPLYING ONE OR MORE SECURITY MEASURES TO DATA IN DATABASES TO ENSURE COMPLIANCE OF THE DATA IN THE DATABASES WITH THE ONE OR MORE DATA SECURITY POLICIES OPERATION 405 represents, or includes, instructions for applying one or more data security measures to data that include, but are not limited to, applying specific encryption, or a defined level of encryption, for the data; the use of tokens or tokenization of data; applying hashes and/or one-way hashes of data; logging all modifications to data; logging all access, or attempts to access, the data; requiring all access to the data be authenticated; implementing specific identification/authentication procedures, such as mandatory multifactor authentication; requiring that all access to the data be associated with authorized roles; logging specific types of access, or attempts to access, the data; logging various processing, or attempts to process or manipulate, the data; applying one or more protective actions to the data in the event of a generalized or specific security event; and/or any other data security policy compliance data deemed necessary to ensure conformance with the data security policies, as discussed herein, and/or as known in the art at the time of filing, and/or as become known in the art after the time of filing.

In one embodiment, once data security policy compliance data representing instructions for applying one or more data security measures to data in databases in order to ensure compliance of the data in the databases with the one or more data security policies, at the data level, is generated at GENERATE DATA SECURITY POLICY COMPLIANCE DATA REPRESENTING INSTRUCTIONS FOR APPLYING ONE OR MORE SECURITY MEASURES TO DATA IN DATABASES TO ENSURE COMPLIANCE OF THE DATA IN THE DATABASES WITH THE ONE OR MORE DATA SECURITY POLICIES OPERATION 405, process flow proceeds to GENERATE DATABASE SECURITY POLICY COMPLIANCE DATA REPRESENTING INSTRUCTIONS FOR APPLYING ONE OR MORE SECURITY MEASURES TO DATABASES CONTAINING DATA IN ORDER TO ENSURE COMPLIANCE OF THE DATABASES WITH THE ONE OR MORE DATA SECURITY POLICIES OPERATION 407.

In one embodiment, at GENERATE DATABASE SECURITY POLICY COMPLIANCE DATA REPRESENTING INSTRUCTIONS FOR APPLYING ONE OR MORE SECURITY MEASURES TO DATABASES CONTAINING DATA IN ORDER TO ENSURE COMPLIANCE OF THE DATABASES WITH THE ONE OR MORE DATA SECURITY POLICIES OPERATION 407 database security policy compliance data associated with the security policies of DEFINE ONE OR MORE DATA SECURITY POLICIES TO BE APPLIED TO DATA OPERATION 403 is generated.

In one embodiment, the database security policy compliance data of GENERATE DATABASE SECURITY POLICY COMPLIANCE DATA REPRESENTING INSTRUCTIONS FOR APPLYING ONE OR MORE SECURITY MEASURES TO DATABASES CONTAINING DATA IN ORDER TO ENSURE COMPLIANCE OF THE DATABASES WITH THE ONE OR MORE DATA SECURITY POLICIES OPERATION 407 represents, or includes, instructions for applying one or more database security measures to databases containing data in order to ensure compliance of the databases with the one or more data security policies of DEFINE ONE OR MORE DATA SECURITY POLICIES TO BE APPLIED TO DATA OPERATION 403 at the database level.

In one embodiment, each of the one or more database security measures of GENERATE DATABASE SECURITY POLICY COMPLIANCE DATA REPRESENTING INSTRUCTIONS FOR APPLYING ONE OR MORE SECURITY MEASURES TO DATABASES CONTAINING DATA IN ORDER TO ENSURE COMPLIANCE OF THE DATABASES WITH THE ONE OR MORE DATA SECURITY POLICIES OPERATION 407 is associated with a different database security classification, calculated as discussed below.

Consequently, in one embodiment, the database security policy compliance data of GENERATE DATABASE SECURITY POLICY COMPLIANCE DATA REPRESENTING INSTRUCTIONS FOR APPLYING ONE OR MORE SECURITY MEASURES TO DATABASES CONTAINING DATA IN ORDER TO ENSURE COMPLIANCE OF THE DATABASES WITH THE ONE OR MORE DATA SECURITY POLICIES OPERATION 407 represents, or includes, instructions for applying one or more database security measures to databases containing data that include, but are not limited to, applying specific encryption, or a defined level of encryption, for the entire databases; the use of tokens or tokenization of data in the databases; applying hashes and/or one-way hashes of data in the databases; logging all modifications to data in the databases; logging all access, or attempts to access, the data in the databases; requiring all access to the data in the databases be authenticated; implementing specific identification/authentication procedures, such as mandatory multifactor authentication; requiring that all access to the databases be associated with authorized roles; logging specific types of access, or attempts to access, the data in the databases; logging various processing, or attempts to process or manipulate, the data in the databases; applying one or more protective actions to the databases in the event of a generalized or specific security event; and/or any other database security policy compliance data deemed necessary to ensure database conformance with the data security policies, as discussed herein, and/or as known in the art at the time of filing, and/or as become known in the art after the time of filing.

In one embodiment, once database security policy compliance data associated with the security policies of DEFINE ONE OR MORE DATA SECURITY POLICIES TO BE APPLIED TO DATA OPERATION 403 is generated at GENERATE DATABASE SECURITY POLICY COMPLIANCE DATA REPRESENTING INSTRUCTIONS FOR APPLYING ONE OR MORE SECURITY MEASURES TO DATABASES CONTAINING DATA IN ORDER TO ENSURE COMPLIANCE OF THE DATABASES WITH THE ONE OR MORE DATA SECURITY POLICIES OPERATION 407, process flow proceeds to OBTAIN ACCESS TO A DATABASE, THE DATABASE CONTAINING DATA THAT IS POTENTIALLY OF ONE OR MORE DATA TYPES AND/OR DATA SECURITY CLASSIFICATIONS OPERATION 409.

In one embodiment, at to OBTAIN ACCESS TO A DATABASE, THE DATABASE CONTAINING DATA THAT IS POTENTIALLY OF ONE OR MORE DATA TYPES AND/OR DATA SECURITY CLASSIFICATIONS OPERATION 409, access to a database is obtained.

In one embodiment, at to OBTAIN ACCESS TO A DATABASE, THE DATABASE CONTAINING DATA THAT IS POTENTIALLY OF ONE OR MORE DATA TYPES AND/OR DATA SECURITY CLASSIFICATIONS OPERATION 409, access to a database is obtained using a data classification discovery agent. In one embodiment, the data classification discovery agent is implemented as code designed to provide access to the databases either via standard communications channels or special database access communication channels.

Methods, means, processes, and procedures for obtaining access to a database are known in the art. Consequently, a more detailed discussion of the various specific methods, means, processes, and procedures for obtaining access to the database is omitted here to avoid detracting from the invention.

In one embodiment, once access to a database is obtained at OBTAIN ACCESS TO A DATABASE, THE DATABASE CONTAINING DATA THAT IS POTENTIALLY OF ONE OR MORE DATA TYPES AND/OR DATA SECURITY CLASSIFICATIONS OPERATION 409, process flow proceeds to SCAN THE DATA IN THE DATABASE TO DETERMINE THE TYPES OF DATA IN THE DATABASE OPERATION 411.

In one embodiment, at SCAN THE DATA IN THE DATABASE TO DETERMINE THE TYPES OF DATA IN THE DATABASE OPERATION 411, the data in the database of OBTAIN ACCESS TO A DATABASE, THE DATABASE CONTAINING DATA THAT IS POTENTIALLY OF ONE OR MORE DATA TYPES AND/OR DATA SECURITY CLASSIFICATIONS OPERATION 409 is scanned to determine the various types of data in the database, and/or the various security classifications, and the security measures applied to each type of data in the database.

In one embodiment, if during the scan of the data in the database of SCAN THE DATA IN THE DATABASE TO DETERMINE THE TYPES OF DATA IN THE DATABASE OPERATION 411, a data type, and/or security classification, associated with any portion of the data in the database cannot be determined, a prompt is provided to the owner of the database to provide information indicating the type, and/or data security classification, of that portion of the data in the database.

In one embodiment, if a data type, and/or security classification, associated with any portion of the data in the database cannot be determined at SCAN THE DATA IN THE DATABASE TO DETERMINE THE TYPES OF DATA IN THE DATABASE OPERATION 411, and/or there is no response to the prompt to provide the data type, and/or security classification, associated with a portion of the data, that portion of the data is, as a default, determined to be of the highest sensitivity type, and therefore requiring the highest levels of protection.

In one embodiment, once the data in the database of OBTAIN ACCESS TO A DATABASE, THE DATABASE CONTAINING DATA THAT IS POTENTIALLY OF ONE OR MORE DATA TYPES AND/OR DATA SECURITY CLASSIFICATIONS OPERATION 409 is scanned to determine the various types of data in the database, and/or the various security classifications, and the security measures applied to each type of data in the database at SCAN THE DATA IN THE DATABASE TO DETERMINE THE TYPES OF DATA IN THE DATABASE OPERATION 411, process flow proceeds to FOR EACH TYPE OF DATA DETERMINED TO BE IN THE DATABASE, USE THE DATA SECURITY POLICY COMPLIANCE DATA TO ENSURE THE SECURITY MEASURES APPLIED TO THE DATA ARE IN CONFORMANCE WITH THE ONE OR MORE DATA SECURITY POLICIES OPERATION 413.

In one embodiment, at FOR EACH TYPE OF DATA DETERMINED TO BE IN THE DATABASE, USE THE DATA SECURITY POLICY COMPLIANCE DATA TO ENSURE THE SECURITY MEASURES APPLIED TO THE DATA ARE IN CONFORMANCE WITH THE ONE OR MORE DATA SECURITY POLICIES OPERATION 413 the security measures applied to each type of data in the database are analyzed to determine if the security measures applied to the data, at the data level, is in compliance with the data security policies of DEFINE ONE OR MORE DATA SECURITY POLICIES TO BE APPLIED TO DATA OPERATION 403.

In one embodiment, if a determination is made at FOR EACH TYPE OF DATA DETERMINED TO BE IN THE DATABASE, USE THE DATA SECURITY POLICY COMPLIANCE DATA TO ENSURE THE SECURITY MEASURES APPLIED TO THE DATA ARE IN CONFORMANCE WITH THE ONE OR MORE DATA SECURITY POLICIES OPERATION 413 that the security measures applied to the data, at the data level, are not in compliance with the data security policies of DEFINE ONE OR MORE DATA SECURITY POLICIES TO BE APPLIED TO DATA OPERATION 403, the owner of the database is prompted to apply the correct security measures to obtain conformance with the one or more data security policies.

In one embodiment, if a determination is made at FOR EACH TYPE OF DATA DETERMINED TO BE IN THE DATABASE, USE THE DATA SECURITY POLICY COMPLIANCE DATA TO ENSURE THE SECURITY MEASURES APPLIED TO THE DATA ARE IN CONFORMANCE WITH THE ONE OR MORE DATA SECURITY POLICIES OPERATION 413 that the security measures applied to the data, at the data level, are not in compliance with the data security policies of DEFINE ONE OR MORE DATA SECURITY POLICIES TO BE APPLIED TO DATA OPERATION 403, the data security policy compliance data of GENERATE DATA SECURITY POLICY COMPLIANCE DATA REPRESENTING INSTRUCTIONS FOR APPLYING ONE OR MORE SECURITY MEASURES TO DATA IN DATABASES TO ENSURE COMPLIANCE OF THE DATA IN THE DATABASES WITH THE ONE OR MORE DATA SECURITY POLICIES OPERATION 405 is used to apply the correct security measures to obtain conformance with the one or more data security policies.

In one embodiment, once the security measures applied to each type of data in the database are analyzed to determine if the security measures applied to the data, at the data level, is in compliance with the data security policies of DEFINE ONE OR MORE DATA SECURITY POLICIES TO BE APPLIED TO DATA OPERATION 403 at FOR EACH TYPE OF DATA DETERMINED TO BE IN THE DATABASE, USE THE DATA SECURITY POLICY COMPLIANCE DATA TO ENSURE THE SECURITY MEASURES APPLIED TO THE DATA ARE IN CONFORMANCE WITH THE ONE OR MORE DATA SECURITY POLICIES OPERATION 413, process flow proceeds to SCAN THE DATA IN THE DATABASE TO DETERMINE THE SECURITY CLASSIFICATIONS AND/OR SECURITY MEASURES APPLIED TO THE DATA IN THE DATABASE OPERATION 415.

In one embodiment, at SCAN THE DATA IN THE DATABASE TO DETERMINE THE SECURITY CLASSIFICATIONS AND/OR SECURITY MEASURES APPLIED TO THE DATA IN THE DATABASE OPERATION 415, the data included in the database of OBTAIN ACCESS TO A DATABASE, THE DATABASE CONTAINING DATA THAT IS POTENTIALLY OF ONE OR MORE DATA TYPES AND/OR DATA SECURITY CLASSIFICATIONS OPERATION 409 is scanned to determine the various types of data in the database, and/or the various security classifications and security measures applied to the data in the database. In one embodiment, the scan of the data in the database of SCAN THE DATA IN THE DATABASE TO DETERMINE THE SECURITY CLASSIFICATIONS AND/OR SECURITY MEASURES APPLIED TO THE DATA IN THE DATABASE OPERATION 415 is performed in addition to the scan of the data in the database of SCAN THE DATA IN THE DATABASE TO DETERMINE THE TYPES OF DATA IN THE DATABASE OPERATION 411.

In one embodiment, the scan of the data in the database of SCAN THE DATA IN THE DATABASE TO DETERMINE THE SECURITY CLASSIFICATIONS AND/OR SECURITY MEASURES APPLIED TO THE DATA IN THE DATABASE OPERATION 415 is performed using the data classification discovery agent. In one embodiment, at the scan of the data in the database of SCAN THE DATA IN THE DATABASE TO DETERMINE THE SECURITY CLASSIFICATIONS AND/OR SECURITY MEASURES APPLIED TO THE DATA IN THE DATABASE OPERATION 415 the data classification discovery agent is used to read the various columns and rows of the data schema used within the database to store data.

In one embodiment, if during the scan of the data in the database at SCAN THE DATA IN THE DATABASE TO DETERMINE THE SECURITY CLASSIFICATIONS AND/OR SECURITY MEASURES APPLIED TO THE DATA IN THE DATABASE OPERATION 415, a data type, and/or security classification, associated with any portion of the data in the database cannot be determined, a prompt is provided to the owner of the database to provide information indicating the type, and/or data security classification, of that portion of the data in the database.

In one embodiment, if a data type, and/or security classification, associated with any portion of the data in the database cannot be determined at SCAN THE DATA IN THE DATABASE TO DETERMINE THE SECURITY CLASSIFICATIONS AND/OR SECURITY MEASURES APPLIED TO THE DATA IN THE DATABASE OPERATION 415, and/or there is no response to the prompt to provide the data type, and/or security classification, associated with a portion of the data, that portion of the data is, as a default, determined to be of the highest sensitivity type, and therefore requiring the highest levels of protection.

In one embodiment, once the data included in the database of OBTAIN ACCESS TO A DATABASE, THE DATABASE CONTAINING DATA THAT IS POTENTIALLY OF ONE OR MORE DATA TYPES AND/OR DATA SECURITY CLASSIFICATIONS OPERATION 409 is scanned to determine the various types of data in the database, and/or the various security classifications and security measures applied to the data in the database at SCAN THE DATA IN THE DATABASE TO DETERMINE THE SECURITY CLASSIFICATIONS AND/OR SECURITY MEASURES APPLIED TO THE DATA IN THE DATABASE OPERATION 415, process flow proceeds to DETERMINE A DATABASE SECURITY CLASSIFICATION TO BE APPLIED TO THE DATABASE OPERATION 417.

In one embodiment, at DETERMINE A DATABASE SECURITY CLASSIFICATION TO BE APPLIED TO THE DATABASE OPERATION 417, the data type/security classification data associated with the database determined at SCAN THE DATA IN THE DATABASE TO DETERMINE THE SECURITY CLASSIFICATIONS AND/OR SECURITY MEASURES APPLIED TO THE DATA IN THE DATABASE OPERATION 415 is used to determine a database security classification to be applied to the entire database of OBTAIN ACCESS TO A DATABASE, THE DATABASE CONTAINING DATA THAT IS POTENTIALLY OF ONE OR MORE DATA TYPES AND/OR DATA SECURITY CLASSIFICATIONS OPERATION 409.

In one embodiment, as a result of the scan at SCAN THE DATA IN THE DATABASE TO DETERMINE THE SECURITY CLASSIFICATIONS AND/OR SECURITY MEASURES APPLIED TO THE DATA IN THE DATABASE OPERATION 415 data type/security classification data for each type of data in the database of OBTAIN ACCESS TO A DATABASE, THE DATABASE CONTAINING DATA THAT IS POTENTIALLY OF ONE OR MORE DATA TYPES AND/OR DATA SECURITY CLASSIFICATIONS OPERATION 409 is recorded. In one embodiment, at DETERMINE A DATABASE SECURITY CLASSIFICATION TO BE APPLIED TO THE DATABASE OPERATION 417 the data type/security classification data associated with the database is then used to determine a database security classification to be applied to the entire database. In other words, in one embodiment, at DETERMINE A DATABASE SECURITY CLASSIFICATION TO BE APPLIED TO THE DATABASE OPERATION 417, a database security classification to be applied to the entire database is determined based, at least in part, on the determined types of data, and/or data security classifications of the data, in the database.

In one embodiment, once the data type/security classification data associated with the database determined at SCAN THE DATA IN THE DATABASE TO DETERMINE THE SECURITY CLASSIFICATIONS AND/OR SECURITY MEASURES APPLIED TO THE DATA IN THE DATABASE OPERATION 415 is used to determine a database security classification to be applied to the entire database of OBTAIN ACCESS TO A DATABASE, THE DATABASE CONTAINING DATA THAT IS POTENTIALLY OF ONE OR MORE DATA TYPES AND/OR DATA SECURITY CLASSIFICATIONS OPERATION 409 at DETERMINE A DATABASE SECURITY CLASSIFICATION TO BE APPLIED TO THE DATABASE OPERATION 417, process flow proceeds to GENERATE DATABASE SECURITY CLASSIFICATION DATA FOR THE DATABASE INDICATING THE DATABASE SECURITY CLASSIFICATION TO BE APPLIED TO THE DATABASE OPERATION 419.

In one embodiment, at GENERATE DATABASE SECURITY CLASSIFICATION DATA FOR THE DATABASE INDICATING THE DATABASE SECURITY CLASSIFICATION TO BE APPLIED TO THE DATABASE OPERATION 419, database security classification data for the database of OBTAIN ACCESS TO A DATABASE, THE DATABASE CONTAINING DATA THAT IS POTENTIALLY OF ONE OR MORE DATA TYPES AND/OR DATA SECURITY CLASSIFICATIONS OPERATION 409 is generated representing, in machine readable form, the determined database security classification to be applied to the entire database of DETERMINE A DATABASE SECURITY CLASSIFICATION TO BE APPLIED TO THE DATABASE OPERATION 417.

In one embodiment, once database security classification data for the database of OBTAIN ACCESS TO A DATABASE, THE DATABASE CONTAINING DATA THAT IS POTENTIALLY OF ONE OR MORE DATA TYPES AND/OR DATA SECURITY CLASSIFICATIONS OPERATION 409 is generated representing, in machine readable form, the determined database security classification to be applied to the entire database of DETERMINE A DATABASE SECURITY CLASSIFICATION TO BE APPLIED TO THE DATABASE OPERATION 417 at GENERATE DATABASE SECURITY CLASSIFICATION DATA FOR THE DATABASE INDICATING THE DATABASE SECURITY CLASSIFICATION TO BE APPLIED TO THE DATABASE OPERATION 419, process flow proceeds to ASSOCIATE THE DATABASE SECURITY CLASSIFICATION DATA FOR THE DATABASE WITH THE DATABASE OPERATION 421.

In one embodiment, at ASSOCIATE THE DATABASE SECURITY CLASSIFICATION DATA FOR THE DATABASE WITH THE DATABASE OPERATION 421, the database security classification for the database of GENERATE DATABASE SECURITY CLASSIFICATION DATA FOR THE DATABASE INDICATING THE DATABASE SECURITY CLASSIFICATION TO BE APPLIED TO THE DATABASE OPERATION 419 is associated with the entire database of OBTAIN ACCESS TO A DATABASE, THE DATABASE CONTAINING DATA THAT IS POTENTIALLY OF ONE OR MORE DATA TYPES AND/OR DATA SECURITY CLASSIFICATIONS OPERATION 409.

In one embodiment, the database security classification for the database is associated with the database at ASSOCIATE THE DATABASE SECURITY CLASSIFICATION DATA FOR THE DATABASE WITH THE DATABASE OPERATION 421 by generating metadata for the database representing the database security classification for the database.

In one embodiment, once the database security classification for the database of GENERATE DATABASE SECURITY CLASSIFICATION DATA FOR THE DATABASE INDICATING THE DATABASE SECURITY CLASSIFICATION TO BE APPLIED TO THE DATABASE OPERATION 419 is associated with the entire database of OBTAIN ACCESS TO A DATABASE, THE DATABASE CONTAINING DATA THAT IS POTENTIALLY OF ONE OR MORE DATA TYPES AND/OR DATA SECURITY CLASSIFICATIONS OPERATION 409 at ASSOCIATE THE DATABASE SECURITY CLASSIFICATION DATA FOR THE DATABASE WITH THE DATABASE OPERATION 421, process flow proceeds to USE THE DATABASE SECURITY CLASSIFICATION DATA FOR THE DATABASE TO SELECT ONE OR MORE SECURITY MEASURES OF THE SECURITY POLICY COMPLIANCE DATA TO BE APPLIED TO THE DATABASE OPERATION 423.

In one embodiment, at USE THE DATABASE SECURITY CLASSIFICATION DATA FOR THE DATABASE TO SELECT ONE OR MORE SECURITY MEASURES OF THE SECURITY POLICY COMPLIANCE DATA TO BE APPLIED TO THE DATABASE OPERATION 423 the database security classification associated with the database of OBTAIN ACCESS TO A DATABASE, THE DATABASE CONTAINING DATA THAT IS POTENTIALLY OF ONE OR MORE DATA TYPES AND/OR DATA SECURITY CLASSIFICATIONS OPERATION 409 at ASSOCIATE THE DATABASE SECURITY CLASSIFICATION DATA FOR THE DATABASE WITH THE DATABASE OPERATION 421 is used to determine what security measures of the security policy compliance data of GENERATE DATABASE SECURITY POLICY COMPLIANCE DATA REPRESENTING INSTRUCTIONS FOR APPLYING ONE OR MORE SECURITY MEASURES TO DATABASES CONTAINING DATA IN ORDER TO ENSURE COMPLIANCE OF THE DATABASES WITH THE ONE OR MORE DATA SECURITY POLICIES OPERATION 407 should be applied to the database.

As noted above, in one embodiment, the database security policy compliance data of GENERATE DATABASE SECURITY POLICY COMPLIANCE DATA REPRESENTING INSTRUCTIONS FOR APPLYING ONE OR MORE SECURITY MEASURES TO DATABASES CONTAINING DATA IN ORDER TO ENSURE COMPLIANCE OF THE DATABASES WITH THE ONE OR MORE DATA SECURITY POLICIES OPERATION 407 represents, or includes, instructions for applying one or more database security measures to databases containing data in order to ensure compliance of the databases with the one or more data security policies of DEFINE ONE OR MORE DATA SECURITY POLICIES TO BE APPLIED TO DATA OPERATION 403 at the database level.

As also noted above, in one embodiment, each of the one or more database security measures of GENERATE DATABASE SECURITY POLICY COMPLIANCE DATA REPRESENTING INSTRUCTIONS FOR APPLYING ONE OR MORE SECURITY MEASURES TO DATABASES CONTAINING DATA IN ORDER TO ENSURE COMPLIANCE OF THE DATABASES WITH THE ONE OR MORE DATA SECURITY POLICIES OPERATION 407 is associated with a different database security classification of ASSOCIATE THE DATABASE SECURITY CLASSIFICATION DATA FOR THE DATABASE WITH THE DATABASE OPERATION 421.

Consequently, in one embodiment, at USE THE DATABASE SECURITY CLASSIFICATION DATA FOR THE DATABASE TO SELECT ONE OR MORE SECURITY MEASURES OF THE SECURITY POLICY COMPLIANCE DATA TO BE APPLIED TO THE DATABASE OPERATION 423 the database security classification associated with the database of OBTAIN ACCESS TO A DATABASE, THE DATABASE CONTAINING DATA THAT IS POTENTIALLY OF ONE OR MORE DATA TYPES AND/OR DATA SECURITY CLASSIFICATIONS OPERATION 409 at ASSOCIATE THE DATABASE SECURITY CLASSIFICATION DATA FOR THE DATABASE WITH THE DATABASE OPERATION 421 is mapped to the security measures of the security policy compliance data of GENERATE DATABASE SECURITY POLICY COMPLIANCE DATA REPRESENTING INSTRUCTIONS FOR APPLYING ONE OR MORE SECURITY MEASURES TO DATABASES CONTAINING DATA IN ORDER TO ENSURE COMPLIANCE OF THE DATABASES WITH THE ONE OR MORE DATA SECURITY POLICIES OPERATION 407 corresponding to the database security classification associated with the database of OBTAIN ACCESS TO A DATABASE, THE DATABASE CONTAINING DATA THAT IS POTENTIALLY OF ONE OR MORE DATA TYPES AND/OR DATA SECURITY CLASSIFICATIONS OPERATION 409.

In other words, in one embodiment, the database security classification for the database is used to determine which security measures of the security policy compliance data must be applied to the database in order to ensure compliance with the data security policies.

In one embodiment, once the database security classification associated with the database of OBTAIN ACCESS TO A DATABASE, THE DATABASE CONTAINING DATA THAT IS POTENTIALLY OF ONE OR MORE DATA TYPES AND/OR DATA SECURITY CLASSIFICATIONS OPERATION 409 at ASSOCIATE THE DATABASE SECURITY CLASSIFICATION DATA FOR THE DATABASE WITH THE DATABASE OPERATION 421 is used to determine what security measures of the security policy compliance data of GENERATE DATABASE SECURITY POLICY COMPLIANCE DATA REPRESENTING INSTRUCTIONS FOR APPLYING ONE OR MORE SECURITY MEASURES TO DATABASES CONTAINING DATA IN ORDER TO ENSURE COMPLIANCE OF THE DATABASES WITH THE ONE OR MORE DATA SECURITY POLICIES OPERATION 407 should be applied to the database at USE THE DATABASE SECURITY CLASSIFICATION DATA FOR THE DATABASE TO SELECT ONE OR MORE SECURITY MEASURES OF THE SECURITY POLICY COMPLIANCE DATA TO BE APPLIED TO THE DATABASE OPERATION 423, process flow proceeds to APPLY THE SELECTED SECURITY MEASURES TO THE DATABASE OPERATION 425.

In one embodiment, at APPLY THE SELECTED SECURITY MEASURES TO THE DATABASE OPERATION 425, the security measures of USE THE DATABASE SECURITY CLASSIFICATION DATA FOR THE DATABASE TO SELECT ONE OR MORE SECURITY MEASURES OF THE SECURITY POLICY COMPLIANCE DATA TO BE APPLIED TO THE DATABASE OPERATION 423 are automatically applied to the database OBTAIN ACCESS TO A DATABASE, THE DATABASE CONTAINING DATA THAT IS POTENTIALLY OF ONE OR MORE DATA TYPES AND/OR DATA SECURITY CLASSIFICATIONS OPERATION 409, at the individual database level.

In one embodiment, once the security measures of USE THE DATABASE SECURITY CLASSIFICATION DATA FOR THE DATABASE TO SELECT ONE OR MORE SECURITY MEASURES OF THE SECURITY POLICY COMPLIANCE DATA TO BE APPLIED TO THE DATABASE OPERATION 423 are automatically applied to the database of OBTAIN ACCESS TO A DATABASE, THE DATABASE CONTAINING DATA THAT IS POTENTIALLY OF ONE OR MORE DATA TYPES AND/OR DATA SECURITY CLASSIFICATIONS OPERATION 409, at the database level at APPLY THE SELECTED SECURITY MEASURES TO THE DATABASE OPERATION 425, process flow proceeds to EXIT OPERATION 430.

In one embodiment, at EXIT OPERATION 430 process 400 for implementing data security policies using database classification is exited to await new data.

Using process 400 for implementing data security policies using database classification, data security policy is implemented at both the data level and the individual database level. As a result, data security policies can be readily applied to data in individual databases in a highly flexible and dynamic manner.

Consequently, process 400 for implementing data security policies using database classification provides the flexibility needed to readily adapt to the dynamic nature of a cloud computing environment, or any computing environment where the type and number of assets, e.g., databases, is capable of rapidly changing. In addition, using process 400 for implementing data security policies using database classification, the data security policies are implemented locally, at the individual database level, so that a user of the data, such as an application developer, is not aware of the implementation of the security policy, e.g. the data security policy is applied at the individual database level in a symmetrically transparent manner, leaving the user with an experience similar to that of storing all data as plain text data.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

As discussed in more detail above, using the above embodiments, with little or no modification and/or input, there is considerable flexibility, adaptability, and opportunity for customization to meet the specific needs of various parties under numerous circumstances.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as, but not limited to, “activating”, “accessing”, “aggregating”, “alerting”, “applying”, “analyzing”, “associating”, “calculating”, “capturing”, “categorizing”, “classifying”, “comparing”, “creating”, “defining”, “detecting”, “determining”, “distributing”, “encrypting”, “extracting”, “filtering”, “forwarding”, “generating”, “identifying”, “implementing”, “informing”, “monitoring”, “obtaining”, “posting”, “processing”, “providing”, “receiving”, “requesting”, “saving”, “sending”, “storing”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

The present invention also relates to an apparatus or system for performing the operations described herein. This apparatus or system may be specifically constructed for the required purposes, or the apparatus or system can comprise a general purpose system selectively activated or configured/reconfigured by a computer program stored on a computer program product as discussed herein that can be accessed by a computing system or other device.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only.

The present invention is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIG.s, or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

1. A system for implementing data security policies using database classification comprising:
at least one processor;
at least one memory coupled to the at least one processor, the at least one memory having stored therein instructions which when executed by any set of the one or more processors, perform a process for implementing data security policies using database classification, the process for implementing data security policies using database classification including:
defining one or more data security policies to be applied to data;
generating database security policy compliance data representing instructions for applying one or more database security measures to databases containing data in order to ensure compliance of the databases with the one or more data security policies, each of the one or more database security measures being associated with a different database security classification;
obtaining access to a database, the database containing data that is potentially of one or more data types and/or data security classifications;
scanning the data in the database to determine the types and/or data security classifications of the data in the database;
determining a database security classification to be applied to the database based, at least in part, on the determined types and/or data security classifications of the data in the database;
generating database security classification data for the database indicating the database security classification to be applied to the database;
associating the database security classification data for the database with the database; and
using the database security classification data for the database to select one or more security measures of the security policy compliance data to be applied to the database.

2. The system for implementing data security policies using database classification of claim 1 wherein at least one of the one or more data security policies to be applied to data is selected from the group of data security policies consisting of:
mandatory encryption of the data;
mandatory encryption of the data using encryption keys of a defined minimal length;
mandatory tokenization of the data; and
mandatory one-way hashing of the data.

3. The system for implementing data security policies using database classification of claim 1 wherein the one or more database security measures include controlling access to databases.

4. The system for implementing data security policies using database classification of claim 3 wherein the one or more database security measures include enforcing minimal identification required to access the databases.

5. The system for implementing data security policies using database classification of claim 1 wherein the one or more database security measures include logging access to the databases.

6. The system for implementing data security policies using database classification of claim 1 wherein the one or more database security measures include logging discover requests for the databases.

7. The system for implementing data security policies using database classification of claim 1 wherein the one or more database security measures include at least one database security measure selected from the group of database security measures consisting of:
logging create table requests for the databases;
creating a snapshot of the databases;
creating a back-up copy of the databases; and
creating a copy of the in-memory image or state of the databases.

8. The system for implementing data security policies using database classification of claim 1 wherein the one or more database security measures include protecting the database in the event of a detected security threat.

9. The system for implementing data security policies using database classification of claim 1 wherein the one or more database security measures include protecting the database in the event of one or more detected specific security threats.

10. The system for implementing data security policies using database classification of claim 1 wherein access to the database is obtained using a data classification discovery agent.

11. The system for implementing data security policies using database classification of claim 1 wherein scanning the data in the database to determine the types and/or data security classifications of the data in the database includes reading the data schema to determine a data security classification applied to various portions of the data in the database.

12. The system for implementing data security policies using database classification of claim 1 wherein scanning the data in the database to determine the types and/or data security classifications of the data in the database includes determining if the data is encrypted.

13. The system for implementing data security policies using database classification of claim 1 wherein if the type and/or data security classification of a portion of the data in the database is not available, a prompt is provided to the owner of the database to provide data indicating the type and/or data security classification of the portion of the data in the database.

14. The system for implementing data security policies using database classification of claim 1 wherein associating the database security classification data for the database with the database includes generating database security classification meta-data for the database indicating the database security classification of the database.

15. A system for implementing data security policies using database classification comprising:
database security policy compliance data representing instructions for applying one or more security measures to databases containing data in order to ensure compliance of the databases with one or more data security policies, each of the one or more database security measures being associated with a different database security classification;
a database, the database containing data that is potentially of one or more data types and/or data security classifications;
a database classification discovery agent;
at least one processor;
at least one memory coupled to the at least one processor, the at least one memory having stored therein instructions which when executed by any set of the one or more processors, perform a process for implementing data security policies using database classification, the process for implementing data security policies using database classification including:
using the database classification discovery agent to obtain access to the database;
scanning the data in the database to determine the types and/or data security classifications of the data in the database;
determining a database security classification to be applied to the database based, at least in part, on the determined types and/or data security classifications of the data in the database;
generating database security classification data for the database indicating the database security classification to be applied to the database;
associating the database security classification data for the database with the database; and
using the database security classification data for the database to select one or more security measures of the database security policy compliance data to be applied to the database.

16. The system for implementing data security policies using database classification of claim 15 wherein at least one of the one or more data security policies to be applied to data is selected from the group of data security policies consisting of:
mandatory encryption of the data;
mandatory encryption of the data using encryption keys of a defined minimal length;
mandatory tokenization of the data; and
mandatory one-way hashing of the data.

17. The system for implementing data security policies using database classification of claim 15 wherein the one or more database security measures include controlling access to databases.

18. The system for implementing data security policies using database classification of claim 17 wherein the one or more database security measures include enforcing minimal identification required to access the databases.

19. The system for implementing data security policies using database classification of claim 15 wherein the one or more database security measures include logging access to the databases.

20. The system for implementing data security policies using database classification of claim 15
wherein the one or more database security measures include at least one database security measure selected from the group of database security measures consisting of:
logging create table requests for the databases;
creating a snapshot of the databases;
creating a back-up copy of the databases; and
creating a copy of the in-memory image or state of the databases.

21. The system for implementing data security policies using database classification of claim 15 wherein the one or more database security measures include logging create table requests for the databases.

22. The system for implementing data security policies using database classification of claim 15 wherein the one or more database security measures include protecting the database in the event of a detected security threat.

23. The system for implementing data security policies using database classification of claim 15 wherein the one or more database security measures include protecting the database in the event of one or more detected specific security threats.

24. The system for implementing data security policies using database classification of claim 15 wherein scanning the data in the database to determine the types and/or data security classifications of the data in the database includes reading the data schema to determine a data security classification applied to various portions of the data in the database.

25. The system for implementing data security policies using database classification of claim 15 wherein scanning the data in the database to determine the types and/or data security classifications of the data in the database includes determining if the data is encrypted.

26. The system for implementing data security policies using database classification of claim 15 wherein if the type and/or data security classification of a portion of the data in the database is not available, a prompt is provided to the owner of the database to provide data indicating type and/or data security classification of the portion of the data in the database.

27. The system for implementing data security policies using database classification of claim 15 wherein associating the database security classification data for the database with the database includes generating database security classification meta-data for the database indicating the database security classification of the database.

28. A system for implementing data security policies using database classification comprising:
at least one processor;
at least one memory coupled to the at least one processor, the at least one memory having stored therein instructions which when executed by any set of the one or more processors, perform a process for implementing data security policies using database classification, the process for implementing data security policies using database classification including:
defining one or more data security policies to be applied to data;
generating data security policy compliance data representing instructions for applying one or more security measures to data in databases in order to ensure compliance of the data in the databases with the one or more data security policies, each of the one or more security measures being associated with a different data security classification;
generating database security policy compliance data representing instructions for applying one or more security measures to databases containing data in order to ensure compliance of the databases with the one or more data security policies, each of the one or more security measures being associated with a different database security classification;
obtaining access to a database, the database containing data that is potentially of one or more data types and/or data security classifications;
scanning the data in the database to determine the types of data in the database;
for each type of data determined to be in the database, using the data security policy compliance data to ensure the security measures applied to the data are in conformance with the one or more data security policies;
scanning the data in the database to determine the security classifications and/or security measures applied to the data in the database;
determining a database security classification to be applied to the database based, at least in part, on the determined security classifications and/or security measures applied to the data in the database;
generating database security classification data for the database indicating the database security classification to be applied to the database;
associating the database security classification data for the database with the database; and
using the database security classification data for the database to select one or more security measures of the security policy compliance data to be applied to the database.

29. The system for implementing data security policies using database classification of claim 28 wherein at least one of the one or more data security policies to be applied to data is selected from the group of data security policies consisting of:
mandatory encryption of the data;
mandatory encryption of the data using encryption keys of a defined minimal length;
mandatory tokenization of the data; and
mandatory one-way hashing of the data.

30. The system for implementing data security policies using database classification of claim 28 wherein the one or more database security measures include controlling access to databases.

31. The system for implementing data security policies using database classification of claim 30 wherein the one or more database security measures include enforcing minimal identification required to access the databases.

32. The system for implementing data security policies using database classification of claim 28 wherein the one or more database security measures include logging access to the databases.

33. The system for implementing data security policies using database classification of claim 28 wherein the one or more database security measures include at least one database security measure selected from the group of database security measures consisting of:
logging create table requests for the databases;
creating a snapshot of the databases;
creating a back-up copy of the databases; and
creating a copy of the in-memory image or state of the databases.

34. The system for implementing data security policies using database classification of claim 28 wherein the one or more database security measures include logging create table requests for the databases.

35. The system for implementing data security policies using database classification of claim 28 wherein the one or more database security measures include protecting the database in the event of a detected security threat.

36. The system for implementing data security policies using database classification of claim 28 wherein the one or more database security measures include protecting the database in the event of one or more detected specific security threats.

37. The system for implementing data security policies using database classification of claim 28 wherein access to the database is obtained using a data classification discovery agent.

38. The system for implementing data security policies using database classification of claim 28 wherein scanning the data in the database to determine the types and/or data security classifications of the data in the database includes reading the data schema to determine a data security classification applied to various portions of the data in the database.

39. The system for implementing data security policies using database classification of claim 28 wherein scanning the data in the database to determine the types and/or data security classifications of the data in the database includes determining if the data is encrypted.

40. The system for implementing data security policies using database classification of claim 28 wherein if the type and/or data security classification of a portion of the data in the database is not available, a prompt is provided to the owner of the database to provide data indicating type and/or data security classification of the portion of the data in the database.

41. The system for implementing data security policies using database classification of claim 28 wherein associating the database security classification data for the database with the database includes generating database security classification meta-data for the database indicating the database security classification of the database.
